(19) United States
(12) Patent Application Publication
(10) Pub. No.: US 2026/0190126 A1
(43) Pub. Date: Jul. 2, 2026

(54) INTER-USER EQUIPMENT COORDINATION WITH CHANNEL OCCUPANCY TIME SHARING FOR SIDELINK

(71) Applicant: QUALCOMM Incorporated, San Diego, CA (US)

(72) Inventors: Qing LI, PRINCETON JUNCTION, NJ (US); Giovanni CHISCI, San Diego, CA (US); Chih-Hao LIU, San Diego, CA (US); Stelios STEFANATOS, San Diego, CA (US); Shijun WU, San Diego, CA (US)

(21) Appl. No.: 19/128,534

(22) PCT Filed: Dec. 22, 2023
(86) PCT No.: PCT/US2023/085817

§ 371 Date: May 8, 2025

(30) Foreign Application Priority Data
Dec. 29, 2022 (GR) 20220101090

(51) Int. Cl. H04W 72/25; H04L 5/00; H04W 74/08

(52) U.S. Cl. CPC H04W 72/25; H04L 5/0005; H04W 74/0866

(57) ABSTRACT

Methods, systems, and devices for wireless communications are described. Generally, the techniques described herein may support inter-user equipment (UE) coordination with channel occupancy time (COT) sharing in sidelink. For examaple, a first UE may transmit (e.g., unicast, broadcast, or groupcast) one or more first sidelink messages initiating a COT. The one or more first sidelink messages may include COT sharing information associated with the COT being shared with at least a second UE, a third UE, or both, where the COT sharing information indicates time and frequency resources within the shared COT. Additionally, the first UE may receive, from the second UE, the third UE, or both, one or more second sidelink messages during the shared COT in response to transmitting the one or more first sidelink messages.

### CROSS REFERENCE

This application is a 371 National Stage of PCT Application No. PCT/US 2023/085817, filed on Dec. 22, 2023, entitled “INTER-USER EQUIPMENT COORDINATION WITH CHANNEL OCCUPANCY TIME SHARING FOR SIDELINK”, which claims priority from Greece Application No. 20220101090 filed on Dec. 29, 2022, and assigned to the assignee hereof. The disclosure of the prior Application is considered part of and is incorporated by reference into this Patent Application.

### FIELD OF TECHNOLOGY

The following relates to wireless communications, including inter-user equipment (UE) coordination with channel occupancy time (COT) sharing for sidelink.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support inter-user equipment (UE) coordination with channel occupancy time (COT) sharing for sidelink. Generally, the techniques described herein may enable a UE to transmit an indication of a set of parameters associated with a COT being shared with one or more additional UEs. For example, a first UE may transmit (e.g., unicast, broadcast, or groupcast) one or more first sidelink messages initiating a COT. The one or more first sidelink messages may include a first set of parameters associated with the COT being shared with at least a second UE, a third UE, or both, where the first set of parameters indicate time and frequency resources within the shared COT. Accordingly, the first UE may receive, from the second UE, the third UE, or both, one or more second sidelink messages during the shared COT in response to transmitting the one or more first sidelink messages.

In some examples, the indicated time and frequency resources may be allocated to the second UE, the third UE, or both, such that the first UE receives the one or more sidelink messages via at least a subset of the allocated time and frequency resources. Conversely, the indicated time and frequency resources may be restricted from use by the second UE, the third UE, or both, such that the first UE receives the one or more sidelink messages outside of the restricted time and frequency resource.

A method for wireless communications at a first UE is described. The method may include transmitting one or more first sidelink messages initiating a COT, the one or more first sidelink messages include a first set of parameters associated with the COT being shared with at least a second UE, a third UE, or both, where the first set of parameters indicate time and frequency resources within the shared COT and receiving, from the second UE, the third UE, or both, one or more second sidelink messages during the shared COT in response to transmitting the one or more first sidelink messages.

An apparatus for wireless communications at a first UE is described. The apparatus may include a processor, memory coupled with the processor, and instructions stored in the memory. The instructions may be executable by the processor to cause the apparatus to transmit one or more first sidelink messages initiating a COT, the one or more first sidelink messages include a first set of parameters associated with the COT being shared with at least a second UE, a third UE, or both, where the first set of parameters indicate time and frequency resources within the shared COT and receive, from the second UE, the third UE, or both, one or more second sidelink messages during the shared COT in response to transmitting the one or more first sidelink messages.

Another apparatus for wireless communications at a first UE is described. The apparatus may include means for transmitting one or more first sidelink messages initiating a COT, the one or more first sidelink messages include a first set of parameters associated with the COT being shared with at least a second UE, a third UE, or both, where the first set of parameters indicate time and frequency resources within the shared COT and means for receiving, from the second UE, the third UE, or both, one or more second sidelink messages during the shared COT in response to transmitting the one or more first sidelink messages.

A non-transitory computer-readable medium storing code for wireless communications at a first UE is described. The code may include instructions executable by a processor to transmit one or more first sidelink messages initiating a COT, the one or more first sidelink messages include a first set of parameters associated with the COT being shared with at least a second UE, a third UE, or both, where the first set of parameters indicate time and frequency resources within the shared COT and receive, from the second UE, the third UE, or both, one or more second sidelink messages during the shared COT in response to transmitting the one or more first sidelink messages.

In some examples of the method, apparatuses, and non-transitory computer-readable medium described herein, receiving the one or more second sidelink messages may include operations, features, means, or instructions for receiving the one or more second sidelink messages via at least a subset of the time and frequency resources based on the time and frequency resources being allocated to the second UE, the third UE, or both.

In some examples of the method, apparatuses, and non-transitory computer-readable medium described herein, receiving the one or more second sidelink messages may include operations, features, means, or instructions for receiving the one or more second sidelink messages outside of the time and frequency resources based on the time and frequency resources being restricted from use by the second UE, the third UE, or both.

In some examples of the method, apparatuses, and non-transitory computer-readable medium described herein, transmitting the one or more first sidelink messages initiating the COT may include operations, features, means, or instructions for unicasting, broadcasting, or groupcasting, the one or more first sidelink messages.

In some examples of the method, apparatuses, and non-transitory computer-readable medium described herein, unicasting the one or more first sidelink messages initiating the COT may include operations, features, means, or instructions for unicasting a third sidelink message of the one or more first sidelink messages to the second UE or the third UE and unicasting a fourth sidelink message of the one or more first sidelink messages to the second UE or the third UE.

Some examples of the method, apparatuses, and non-transitory computer-readable medium described herein may further include operations, features, means, or instructions for transmitting a third sidelink message sharing the COT, the third sidelink message including a second set of parameters associated with the shared COT, where the second set of parameters indicate second time and frequency resources within the shared COT and receiving one or more fourth sidelink messages during the shared COT based on the second set of parameters.

In some examples of the method, apparatuses, and non-transitory computer-readable medium described herein, the COT may be shared with at least the second UE, the third UE, a fourth UE, or any combination thereof and the one or more fourth sidelink messages may be received from the second UE, the third UE, or the fourth UE, or combination thereof.

In some examples of the method, apparatuses, and non-transitory computer-readable medium described herein, receiving the one or more second sidelink messages may include operations, features, means, or instructions for receiving, from the second UE or the third UE, the one or more second sidelink messages based on a first identifier (ID) associated with the shared COT matching a second ID associated with the second UE or the third UE, respectively, where the first set of parameters includes the first ID.

In some examples of the method, apparatuses, and non-transitory computer-readable medium described herein, the first ID may be a UE ID or a destination ID.

In some examples of the method, apparatuses, and non-transitory computer-readable medium described herein, the one or more first sidelink messages indicate a second set of parameters associated with second time and frequency resources within the COT and the method, apparatuses, and non-transitory computer-readable medium may include further operations, features, means, or instructions for receiving, from the second UE or the third UE, one or more third sidelink messages based on a third ID associated with the shared COT matching a fourth ID associated with the second UE or the third UE, respectively, where the second set of parameters includes the third ID.

In some examples of the method, apparatuses, and non-transitory computer-readable medium described herein, the first set of parameters includes one or more offsets in time, one or more time durations, one or more starting points in time, one or more resource block (RB) sets, one or more subchannels, one or more interlaces, or any combination thereof, associated with the time and frequency resources.

In some examples of the method, apparatuses, and non-transitory computer-readable medium described herein, the first set of parameters includes one or more UE IDs, one or more destination IDs, one or more priorities, one or more channel access priority classes, or any combination thereof.

In some examples of the method, apparatuses, and non-transitory computer-readable medium described herein, receiving the one or more second sidelink messages may include operations, features, means, or instructions for receiving the one or more second sidelink messages based on a destination ID associated with the one or more second sidelink messages matching an IDs associated with the first UE.

A method for wireless communications at a first UE is described. The method may include receiving, from a second UE, one or more first sidelink messages initiating a COT, the one or more first sidelink messages include a first set of parameters associated with the COT being shared with at least a second UE, a third UE, or both, where the first set of parameters indicate time and frequency resources within the shared COT and transmitting one or more second sidelink messages during the shared COT in response to receiving the one or more first sidelink message.

An apparatus for wireless communications at a first UE is described. The apparatus may include a processor, memory coupled with the processor, and instructions stored in the memory. The instructions may be executable by the processor to cause the apparatus to receive, from a second UE, one or more first sidelink messages initiating a COT, the one or more first sidelink messages include a first set of parameters associated with the COT being shared with at least a second UE, a third UE, or both, where the first set of parameters indicate time and frequency resources within the shared COT and transmit one or more second sidelink messages during the shared COT in response to receiving the one or more first sidelink message.

Another apparatus for wireless communications at a first UE is described. The apparatus may include means for receiving, from a second UE, one or more first sidelink messages initiating a COT, the one or more first sidelink messages include a first set of parameters associated with the COT being shared with at least a second UE, a third UE, or both, where the first set of parameters indicate time and frequency resources within the shared COT and means for transmitting one or more second sidelink messages during the shared COT in response to receiving the one or more first sidelink message.

A non-transitory computer-readable medium storing code for wireless communications at a first UE is described. The code may include instructions executable by a processor to receive, from a second UE, one or more first sidelink messages initiating a COT, the one or more first sidelink messages include a first set of parameters associated with the COT being shared with at least a second UE, a third UE, or both, where the first set of parameters indicate time and frequency resources within the shared COT and transmit one or more second sidelink messages during the shared COT in response to receiving the one or more first sidelink message.

In some examples of the method, apparatuses, and non-transitory computer-readable medium described herein, transmitting the one or more second sidelink messages may include operations, features, means, or instructions for transmitting the one or more second sidelink messages via at least a subset of the time and frequency resources based on the time and frequency resources being allocated to at least the first UE.

Some examples of the method, apparatuses, and non-transitory computer-readable medium described herein may further include operations, features, means, or instructions for selecting the subset of the time and frequency resources based on the time and frequency resources being allocated to at least the first UE.

In some examples of the method, apparatuses, and non-transitory computer-readable medium described herein, the subset of the time and frequency resources may be selected randomly.

Some examples of the method, apparatuses, and non-transitory computer-readable medium described herein may further include operations, features, means, or instructions for measuring a channel associated with the COT over the time and frequency resources, where selecting the subset of the time and frequency resources may be based on the measuring.

In some examples of the method, apparatuses, and non-transitory computer-readable medium described herein, transmitting the one or more second sidelink messages may include operations, features, means, or instructions for transmitting the one or more second sidelink messages outside of the time and frequency resources based on the time and frequency resources being restricted from use by at least the first UE.

Some examples of the method, apparatuses, and non-transitory computer-readable medium described herein may further include operations, features, means, or instructions for receiving a third sidelink message sharing the COT, the third sidelink message including a second set of parameters associated with the shared COT, where the second set of parameters indicate second time and frequency resources within the shared COT and transmitting one or more fourth sidelink messages during the shared COT based on the second set of parameters.

In some examples of the method, apparatuses, and non-transitory computer-readable medium described herein, transmitting the one or more second sidelink messages may include operations, features, means, or instructions for transmitting the one or more second sidelink messages based on a first ID associated with the shared COT matching an second ID associated with the first UE, where the first set of parameters includes the first ID.

Some examples of the method, apparatuses, and non-transitory computer-readable medium described herein may further include operations, features, means, or instructions for validating the first ID associated with the shared COT matches the second ID associated with the first UE.

In some examples of the method, apparatuses, and non-transitory computer-readable medium described herein, the first ID may be a UE ID or a destination ID.

In some examples of the method, apparatuses, and non-transitory computer-readable medium described herein, the first set of parameters includes one or more offsets in time, one or more time durations, one or more starting points in time, one or more RB sets, one or more subchannels, one or more interlaces, or any combination thereof, associated with the time and frequency resources.

In some examples of the method, apparatuses, and non-transitory computer-readable medium described herein, the first set of parameters includes one or more UE IDs, one or more destination IDs, one or more priorities, one or more channel access priority classes, or any combination thereof.

Some examples of the method, apparatuses, and non-transitory computer-readable medium described herein may further include operations, features, means, or instructions for transmitting, to a fourth UE, a third sidelink message signaling a second set of parameters enabling the COT to be shared with at least the second UE and the fourth UE, where the second set of parameters indicate at least a subset of the time and frequency resources within the shared COT.

In some examples of the method, apparatuses, and non-transitory computer-readable medium described herein, the one or more second sidelink messages includes an indication of a destination ID matching an ID associated with the second UE.

### BRIEF DESCRIPTION OF THE DRAWINGS

FIG. 1 illustrates an example of a wireless communications system that supports inter-user equipment coordination with channel occupancy time sharing for sidelink in accordance with one or more aspects of the present disclosure.

FIG. 2 illustrates an example of a wireless communications systems that supports inter-user equipment coordination with channel occupancy time sharing for sidelink in accordance with one or more aspects of the present disclosure.

FIG. 3 illustrates an example of a time resource allocation that supports inter-user equipment coordination with channel occupancy time sharing for sidelink in accordance with one or more aspects of the present disclosure.

FIG. 4 illustrates examples of frequency resource allocations that supports inter-user equipment coordination with channel occupancy time sharing for sidelink in accordance with one or more aspects of the present disclosure.

FIG. 5 illustrates an example of a process flow that supports inter-user equipment coordination with channel occupancy time sharing for sidelink in accordance with one or more aspects of the present disclosure.

FIG. 6 illustrates an example of a process flow that supports inter-user equipment coordination with channel occupancy time sharing for sidelink in accordance with one or more aspects of the present disclosure.

FIGS. 7 and 8 illustrate block diagrams of devices that support inter-user equipment coordination with channel occupancy time sharing for sidelink in accordance with one or more aspects of the present disclosure.

FIG. 9 illustrates a block diagram of a communications manager that supports inter-user equipment coordination with channel occupancy time sharing for sidelink in accordance with one or more aspects of the present disclosure.

FIG. 10 illustrates a diagram of a system including a device that supports inter-user equipment coordination with channel occupancy time sharing for sidelink in accordance with one or more aspects of the present disclosure.

FIGS. 11 and 12 illustrate flowcharts showing methods that support inter-user equipment coordination with channel occupancy time sharing for sidelink in accordance with one or more aspects of the present disclosure.

### DETAILED DESCRIPTION

In some sidelink communications systems, multiple user equipments (UEs) may share a channel occupancy time (COT). That is, a first UE, which may be referred to as a COT initiator, may obtain (e.g., initiate) a COT by transmitting a first sidelink messages to a second UE, which may be referred to as a first COT responder, and may share the COT with the first COT responder, such that the first COT responder may transmit a second sidelink transmissions to the COT initiator (e.g., in response to sharing the COT initiated via the first sidelink message) within the shared COT. Additionally, the COT initiator may transmit a third sidelink message to a third UE, which may be referred to as a second COT responder, such that the second COT responder may transmit a fourth sidelink message to the COT initiator (e.g., in response to sharing the COT shared via the third sidelink message) within the shared COT.

However, in some cases, the first COT responder may transmit the second sidelink message (e.g., to the COT initiator) within the shared COT via time and frequency resources that at least partially overlap with time and frequency resources used by the COT initiator to transmit the third sidelink message to the second COT responder (e.g., the second sidelink message and the third sidelink message are transmitted at the same time). In such cases, the COT initiator may not receive the second sidelink message (e.g., due to the COT initiator operating in half-duplex), interference may occur between the sidelink messages, or both. Additionally, or alternatively, the first COT responder may transmit the second sidelink message (e.g., to the COT initiator) within the shared COT via time and frequency resources that at least partially overlap with time and frequency resources used by the fourth sidelink message (e.g., to the COT initiator) within the shared COT (e.g., the second sidelink message and the fourth sidelink message are transmitted at the same time). In such cases, the COT initiator may not receive one or more of the second sidelink message and the fourth sidelink message, interference may occur between the sidelink messages, or both.

Accordingly, techniques described herein may support inter-UE coordination with COT sharing for sidelink communications. That is, a COT initiator (e.g., first UE) may transmit COT sharing inter-UE coordination (CSIUC) information (e.g., in sidelink control information (SCI)) to one or more COT responders (e.g., a second UE, a third UE, or both) to support COT sharing among the one or more COT responders. For example, the COT initiator may communicate (e.g., unicast, broadcast, or groupcast) one or more first sidelink messages initiating a COT, where the one or more first sidelink messages indicate CSIUC information associated with sharing the COT with at least a first COT responder, a second COT responder, or both. In some examples, the CSIUC information may indicate preferred time and frequency resources (e.g., allocated time and frequency resources) within the shared COT that the first COT responder, the second COT responder, or both, may use to transmit respectively one or more second sidelink messages based on the one or more first sidelink messages. Alternatively, the CSIUC information may indicate non-preferred time and frequency resources (e.g., restricted time and frequency resources) within the shared COT that the first COT responder, the second COT responder, or both, may avoid using (e.g., may not use) to transmit the one or more second sidelink messages in response to the one or more first sidelink messages. As a result, the COT initiator may receive the one or more second sidelink messages from the first COT responder, the second COT responder, or both, within the shared COT based on the indicated CSIUC information.

Aspects of the disclosure are initially described in the context of wireless communications systems. Aspects of the disclosure are then described in the context of a timing resource allocation, frequency resource allocations, and a process flow. Aspects of the disclosure are further illustrated by and described with reference to apparatus diagrams, system diagrams, and flowcharts that relate to inter-user equipment coordination with channel occupancy time sharing for sidelink.

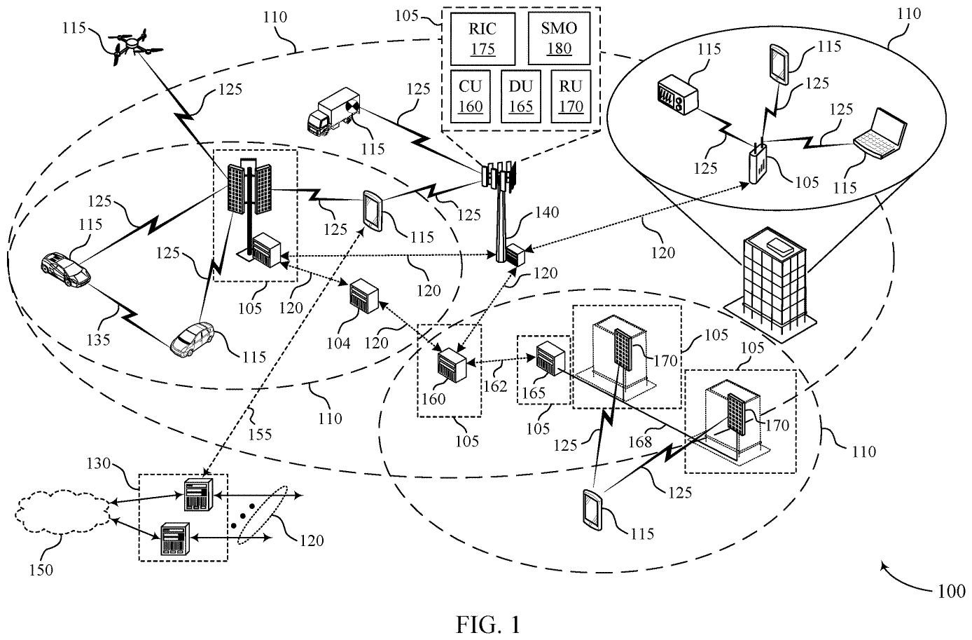

FIG. 1 illustrates an example of a wireless communications system 100 that supports inter-UE coordination with COT sharing for sidelink in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125.

The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L 3 ), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support inter-user equipment coordination with channel occupancy time sharing for sidelink as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Accordingly, techniques described herein may support inter-UE coordination with COT sharing for sidelink communications. That is, a first UE 115 (e.g., a COT initiator) may transmit CSIUC information to one or more additional UEs 115, such as a second UE 115, a third UE 115, or both, to support COT sharing among the one or more UEs 115. For example, the COT initiator may communicate (e.g., unicast, broadcast, or groupcast) one or more first sidelink messages initiating a COT, where the one or more first sidelink messages indicate CSIUC information associated with sharing the COT with at least the second UE 115, the third UE 115, or both. In some examples, the CSIUC information may indicate preferred time and frequency resources (e.g., allocated time and frequency resources) within the shared COT that the second UE 115, the third UE 115, or both, may use to transmit one or more second sidelink messages in response to the one or more first sidelink messages. Alternatively, the CSIUC information may indicate non-preferred time and frequency resources (e.g., restricted time and frequency resources) within the shared COT that the second UE 115, the third UE 115, or both, may avoid using (e.g., may not use) to transmit the one or more second sidelink messages in response to the one or more first sidelink messages. As a result, the UE 115 may receive the one or more second sidelink messages from the second UE 115, the third UE 115, or both, within the shared COT based on the indicated CSIUC information.

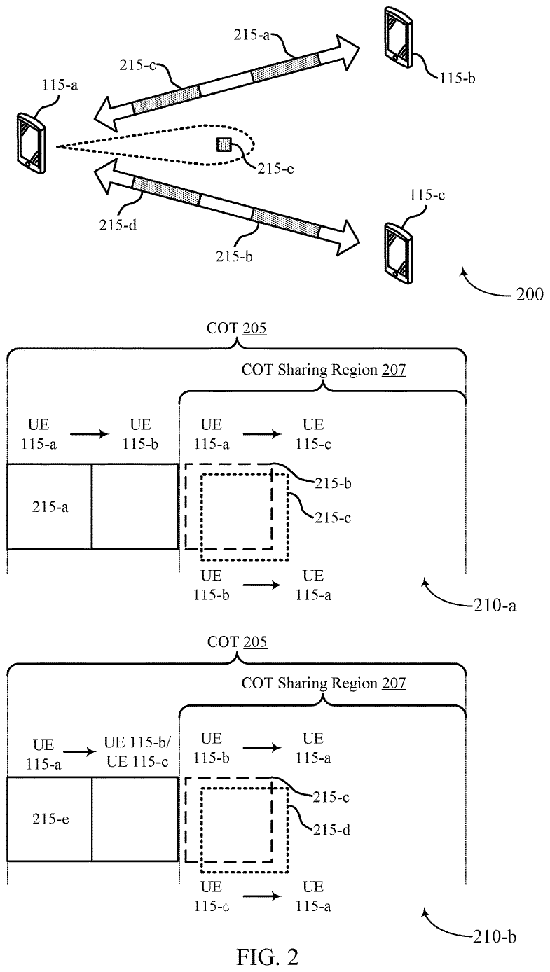

FIG. 2 illustrates an example of a wireless communications system 200 that supports inter-UE coordination with COT sharing for sidelink in accordance with one or more aspects of the present disclosure. In some examples, the wireless communications system 200 may implement or be implemented by aspects of the wireless communications system 100. For example, the wireless communications system 200 may include one or more network entities 105 and one or more UEs 115 (e.g., a UE 115-a, a UE 115-b, and a UE 115-c), which may be examples of the corresponding devices as described with reference to FIG. 1. The wireless communications system 200 may support communication of CSIUC information associated with sharing a COT with multiple UEs 115.

In some sidelink communications systems (e.g., unlicensed), a UE 115, such as the UE 115-a, may access a channel (e.g., perform channel access) via a listen before talk (LBT) procedure (e.g., on PC5, sidelink LBT). The UE 115-a may perform the LBT procedure (e.g., type 1 channel access procedure) for a sidelink communication associated with a channel access priority class (CAPC). In some examples, the UE 115-a (e.g., COT initiator) may obtain a COT 205 (e.g., sidelink COT 205) via one or more first sidelink transmissions, such as a sidelink message 215-a (e.g., transmission of the sidelink message 215-a), to a second UE 115, such as the UE 115-b (e.g., after a successful sidelink LBT with Type 1 channel access procedure). In some examples, the UE 115-a may share the COT 205 with one or more additional UEs 115, (e.g., the UE 115-b, a UE 115-c, or both), to avoid performing an LBT procedure (e.g., sidelink LBT Type 1 operation) for one or more additional sidelink messages 215 (e.g., one or more second transmissions to share the COT initiated by the first sidelink transmission 215-a). In such cases, the one or more additional sidelink messages 215 may include a retransmission of the sidelink message 215-a (e.g., with the same transport block (TB)) to the UE 115-b, an additional sidelink message 215 different than the sidelink message 215-a (e.g., a transmission with a different TB) to the UE 115-b, or an additional sidelink message 215, such as the sidelink message 215-b, to a third UE 115, such as the UE 115-c.

As such, the UE 115-a (e.g., COT initiator, transmitter UE 115) may obtain (e.g., initiate) the COT 205 via transmission of the sidelink message 215-a to the UE 115-b and may share the COT 205 with the UE 115-b, such that the UE 115-b (e.g., a COT responder, responder UE 115) may transmit one or more sidelink messages 215, such as the sidelink message 215-c, to the UE 115-a, within the COT 205. In some examples (e.g., when performing sidelink synchronization signal block (S-SSB) transmissions), the UE 115-b (e.g., responding UE 115) may utilize the COT 205 shared by the UE 115-a based on (e.g., when) the UE 115-b transmitting (e.g., intends to transmit) S-SSB within one or more resource block (RBs) sets within the shared COT 205. In some other examples (e.g., when performing physical sidelink feedback channel (PSFCH) transmissions), the UE 115-b may utilize the COT 205 shared by the UE 115-a based on (e.g., when) the UE 115-b transmitting, to the UE 115-a, at least one PSFCH transmission via a symbol (e.g., slot) within one or more resource block (RB) sets corresponding to the shared COT 205 (e.g., the at least one PSFCH transmission is intended for the UE 115-a). In some other examples, (e.g., when performing physical sidelink shared channel (PSSCH)/physical sidelink control channel (PSCCH) transmissions), the UE 115-b may utilize the COT 205 shared by the UE 115-a based on (e.g., when) the UE 115-b transmitting, to the UE 115-a, PSSCH transmissions, PSCCH transmissions, or both, within one or more RB sets corresponding to the shared COT 205 (e.g., the PSSCH transmissions, the PSCCH transmissions, or both, are intended for the UE 115-a).

Additionally (e.g., when the UE 115-a obtains the COT 205 via transmission of the sidelink message 215-a to the UE 115-b), the UE 115-a may transmit a sidelink message 215 (e.g., one or more second transmissions), such as the sidelink message 215-b, to the UE 115-c. In such cases, the UE 115-a may share the COT 205 with the UE 115-c, such that the UE 115-c may transmit a sidelink message 215, such as the sidelink message 215-d, to the UE 115-a within the COT 205 (e.g., in response to the sidelink message 215-b).

However, when multiple UEs 115, such as the UE 115-a, the UE 115-b, and the UE 115-c, share the COT 205, the UEs 115 may try to use one or more resources (e.g., one or more slots) following (e.g., immediately after) transmission of a sidelink message 215 initiating the COT 205 (e.g., before a shared COT region, such as COT Sharing Region 207, after the UE 115-a performs a channel access procedure according to a time gap related to the sidelink message 215-a). As such, the UEs 115 may share resources (e.g., compete for resources) associated with the COT 205, which may cause LBT overhead associated with the resources within the COT 205 (e.g., every slot within the COT 205), may cause collisions between sidelink messages 215 transmitted by each UE 115, or both.

For example, as depicted in COT sharing scenario 210-a, the UE 115-a may transmit the sidelink message 215-a, to the UE 115-b, initiating the COT 205. Additionally (e.g., after initiating the COT 205), the UE 115-a may transmit the sidelink message 215-b to the UE 115-c within the COT 205 via resource (e.g., time and frequency resources) that at least partially overlap with resources used by the UE 115-b to transmit the sidelink message 215-c to the UE 115-a (e.g., in response to sharing the COT initiated via the sidelink message 215-a) within the COT 205. That is, the UE 115-a may transmit the sidelink message 215-b to the UE 115-c at a same time (e.g., within a time threshold) as the UE 115-b transmits the sidelink message 215-c to the UE 115-a. As such, a collision (e.g., interference exceeding a threshold) may occur between the sidelink message 215-b and the sidelink message 215-c (e.g., due to half-duplex operations at the UE 115-a). In such cases, the UE 115-c may fail to receive the sidelink message 215-b, the UE 115-a may fail to receive the sidelink message 215-c, or both.

Additionally, or alternatively, as depicted in COT sharing scenario 210-b, the UE 115-a may transmit the sidelink message 215-a, to the UE 115-b, initiating the COT 205. Additionally (e.g., after initiating the COT 205), the UE 115-b may transmit the sidelink message 215-c to the UE 115-a (e.g., in response to sharing the COT initiated via the sidelink message 215-a) within the COT 205 via resource that at least partially overlap with resources used by the UE 115-c to transmit the sidelink message 215-d to the UE 115-a (e.g., in response to sharing the COT initiated via the sidelink message 215-b) within the COT 205. That is, the UE 115-b may transmit the sidelink message 215-c to the UE 115-a at a same time (e.g., within a time threshold) as the UE 115-c transmits the sidelink message 215-d to the UE 115-a. As such, a collision may occur between the sidelink message 215-c and the sidelink message 215-d. In such cases, the UE 115-a may fail to receive the sidelink message 215-c, the sidelink message 215-d, or both.

Accordingly, techniques described herein may support inter-UE coordination with COT sharing for sidelink communications. That is, a first UE 115, such as the UE 115-a, may transmit CSIUC information (e.g., via MAC-CE, SCI 2, or both) to one or more additional UEs 115, such as the UE 115-b, the UE 115-c, or both, to support COT sharing among the one or more additional UEs 115. For example, the UE 115-a may transmit (e.g., unicast, broadcast, or groupcast) one or more first sidelink messages 215, such as the sidelink message 215-a (e.g., a unicast to the UE 115-b), the sidelink message 215-b (e.g., a unicast to UE 115-c), a sidelink message 215-e (e.g., a groupcast or broadcast to UE 115-b and UE 115-c), or any combination thereof, initiating a COT 205. Additionally, the UE 115-a may transmit CSIUC information with the one or more first sidelink messages 215 (e.g., the UE 115-a may transmit a CSIUC information MAC-CE with the one or more first sidelink messages 215) for sharing the COT with the UE 115-b, the UE 115-c, or both. In other words, the UE 115-a may perform one or more first transmissions, including the one or more first sidelink messages 215 and the CSIUC information (e.g., a set of parameters) associated with sharing the COT 205 with the UE 115-b, the UE 115-c, or both. For example, the UE 115-a may broadcast or groupcast the sidelink message 215-e including (e.g., signaling) CSIUC information to the UE 115-b, the UE 115-c, or both. Additionally, or alternatively, the UE 115-a may unicast, to the UE 115-b, the sidelink message 215-a including first CSIUC information, unicast the sidelink message 215-b, to the UE 115-c, including second CSIUC information (e.g., the first CSIUC information may be the same as or different than the second CSIUC information), or both (e.g., multiple unicasts to different UEs 115). Additionally, or alternatively, the UE 115-a may unicast the sidelink message 215-a including the first CSIUC information to the UE 115-b and unicast an additional sidelink message 215 including the second CSIUC information to the UE 115-b. (e.g., multiple unicasts to the same UE 115).

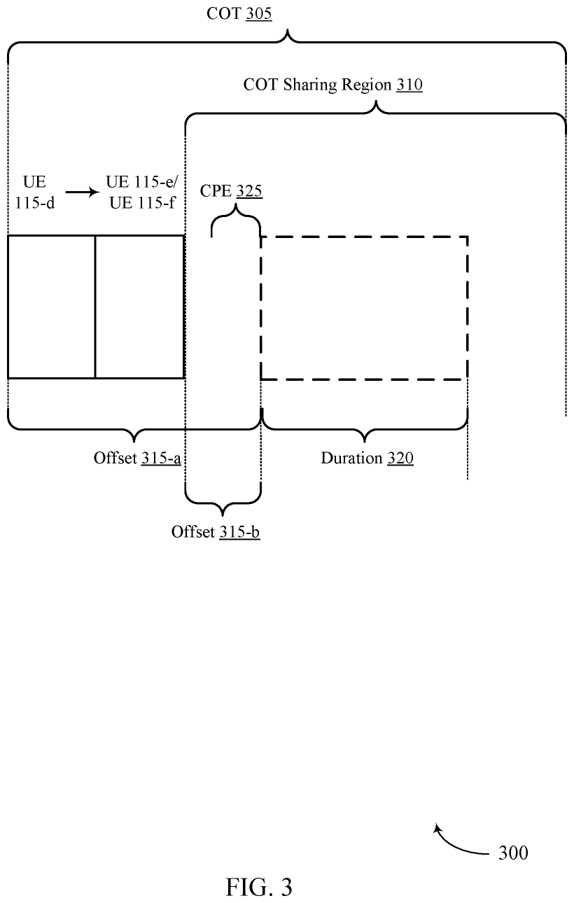

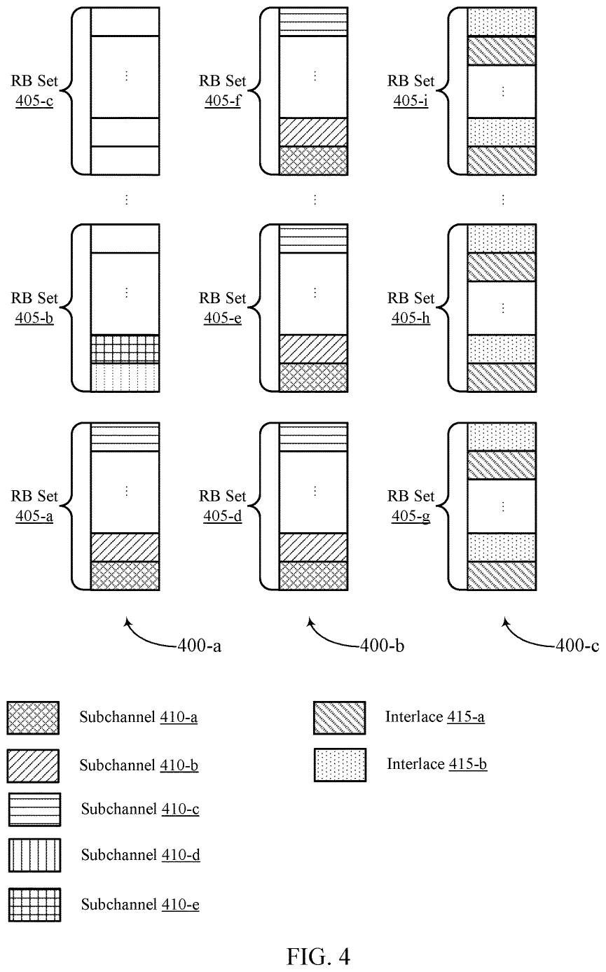

In some cases, CSIUC information may indicate time and frequency resources within the COT 205, as described with reference to FIGS. 3 and 4. In some examples, the indicated time and frequency resources may be preferred time and frequency resources within the COT 205. That is, the indicated time and frequency resources may be allocated to the UE 115-b, the UE 115-c, or both, such that the UE 115-b, the UE 115-c, or both, may transmit the sidelink message 215-c, the sidelink message 215-d, or both, respectively, (e.g., in response to sharing the COT initiated via the sidelink message 15-a, the sidelink message 215-b, the sidelink message 215-e, or any combination thereof) via at least a subset of the allocated time and frequency resources. In such cases, the UE 115-a may refrain from transmitting one or more additional sidelink messages 215 (e.g., within the COT 205) via the indicated time and frequency resources and/or the UE 115-a may monitor for one or more additional sidelink messages 215 (e.g., the sidelink message 215-c, the sidelink message 215-d, or both within the COT 205) from the UE 115-b, the UE 115-c, or both via the indicated time and frequency resources. Alternatively, the indicated time and frequency resources may be non-preferred time and frequency resources within the COT 205. That is, the indicated time and frequency resources may be restricted from use by the UE 115-b, the UE 115-c, or both, such that the UE 115-b, the UE 115-c, or both, may transmit the sidelink message 215-c, the sidelink message 215-d, or both, respectively, outside of the indicated time and frequency resources (e.g., may refrain from transmitting via the indicated time and frequency resources). In such cases, the UE 115-a may transmit one or more additional sidelink messages 215 via the indicated time and frequency resources and/or the UE 115-a may not monitor for one or more additional sidelink messages 215 (e.g., the sidelink message 215-c, the sidelink message 215-d, or both within the COT 205) via the indicated time and frequency resources.

Additionally, or alternatively, CSIUC information may include an indication of one or more identifiers (IDs), one or more CAPCs, one or more priorities, or any combination thereof. In some cases, the CSIUC information may include one or more IDs (e.g., UE IDs) associated with one or more UEs 115 sharing the COT 205 (e.g., responder UEs 115). For example, the CSIUC information may include a first UE ID associated with the UE 115-b, a second UE ID associated with the UE 115-c, or both. Additionally, the first UE ID may be associated with first time resource (e.g., time division multiplexing (TDM) with slots for sharing the COT with other responder UEs 115, such as the UE 115-c), first frequency resources (e.g., frequency division multiplexing (FDM) with interlaces for sharing the COT with other responder UEs 115, such as the UE 115-c), or both, and the second UE ID may be associated with second time resources, second frequency resources, or both. As such (e.g., if the first time resources and the first frequency resource are preferred resources), the UE 115-b may transmit the sidelink message 215-c via the first time resources, the first frequency resources, or both, and the UE 115-c may transmit the sidelink message 215-d via the second time resources, the second frequency resources, or both. Additionally, or alternatively, the CSIUC information may include a destination ID (e.g., associated with the responder UEs 115). For example, the sidelink message 215-a may be associated with a first destination ID further associated with the UE 115-b (e.g., a unicast message), the sidelink message 215-b may be associated with a second destination ID further associated with the UE 115-c (e.g., a unicast message), and the sidelink message 215-e may be associated with a third destination ID further associated with the UE 115-b, the UE 115-c, or both (e.g., a groupcast or broadcast message).

As an illustrative example, the UE 115-b may receive the sidelink message 215-a (e.g., a transmission of the sidelink message 215-a) indicating (e.g., carrying) CSIUC information. The CSIUC information may include a destination ID, a UE ID, or both. The UE 115-b may validate (e.g., check) that the destination ID indicated via the CSIUC information is the same as a first ID associated with the UE 115-b. That is, the UE 115-b may perform validation of the destination ID to validate the UE 115-b is a responder UE 115 associated with the COT 205 (e.g., may share the COT 205) and validate resources indicated via the CSIUC information for sharing the COT 205 (e.g., validate the resources are allocated to or restricted from use by the UE 115-b). Additionally, or alternatively, the UE 115-b may validate that the UE ID (e.g., responder ID) indicated via the CSIUC information is the same as a second ID (e.g., which may be the same or different than the first ID) associated with the UE 115-b. That is, the UE 115-b may perform validation of the UE ID to validate resources indicated via the CSIUC information for sharing the COT 205 (e.g., validate the resources are allocated to or restricted from use by the UE 115-b). Similarly, the UE 115-c may receive the sidelink message 215-b (e.g., a transmission of the sidelink message 215-b) indicating (e.g., carrying) CSIUC information. The CSIUC information may include a destination ID, a UE ID, or both. The UE 115-c may perform validation of the destination ID, the UE ID, or both to validate that the UE 115-b is a responder UE 115 associated with the COT 205 (e.g., may share the COT 205) and validate resources indicated via the CSIUC information for sharing the COT 205 (e.g., validate the resources are allocated to or restricted from use by the UE 115-b).

As such, the UE 115-b, the UE 115-c, or both, may select at least a subset time and frequency resources based on CSIUC information (e.g., and COT indication). In some cases, the UE 115-b, the UE 115-c, or both, may perform full sensing or partial sensing to select the time and frequency resources. For example, the UE 115-b, the UE 115-c, or both, may measure a channel associated with the COT 205 over time and frequency resources indicated via the CSIUC information (e.g., preferred time and frequency resources or resources outside of non-preferred time and frequency resources) and select the subset of time and frequency resources based on the measuring. Additionally, or alternatively, the UE 115-b, the UE 115-c, or both, may randomly selection the subset of time and frequency resources within the COT 205 (e.g., from preferred time and frequency resources or from resources outside of non-preferred time and frequency resources).

Though described in the context of a UE 115-a, a UE 115-b, and a UE 115-c, this is not to be regarded as a limitation of the present disclosure. In this regard, any quantity of UEs 115 may share a COT 205.

FIG. 3 illustrates an example of a time resource allocation 300 that supports inter-UE coordination with COT sharing for sidelink in accordance with one or more aspects of the present disclosure. In some examples, the time resource allocation 300 may implement or be implemented by aspects of the wireless communications system 100 and the wireless communications system 200. For example, the time resource allocation 300 may be implemented by one or more network entities 105 and one or more UEs 115 (e.g., a UE 115-d, a UE 115-e, and a UE 115-f), which may be examples of the corresponding devices as described with reference to FIG. 1. The time resource allocation 300 may support communication of CSIUC information associated with sharing a COT 305 with multiple UEs 115 (e.g., using different time resource allocations).

As described previously, a first UE 115, such as a UE 115-d, may transmit (e.g., unicast, broadcast, or groupcast) one or more transmissions (e.g., sidelink messages) to one or more additional UEs 115, such as a UE 115-e, a UE 115-f, or both, including CSIUC information (e.g., a set of parameters) associated with sharing a COT 305 during a COT sharing region 310. The CSIUC information may indicate time (e.g., remaining COT duration 320) and frequency resources (e.g., the RB set(s)) within the COT 305 or the COT sharing region 310. For example, the CSIUC information may indicate preferred time and frequency resources, non-preferred time and frequency resources, or both.

In some examples, the CSIUC information may indicate time resources allocation based on one or more offsets 315, one or more durations 320, one or more cyclic prefix extensions (CPE) 325, one or more starting points (e.g., with the CPE), or any combination thereof. For example, the CSIUC information may indicate an offset 315-a (e.g., referenced from a beginning of the COT 305, which may be referred to as a COT 305 starting point), an offset 315-b (e.g., referenced from a beginning of the COT sharing region 310, which may be referred to as a COT 305 sharing starting point or a COT sharing region 310 starting point), or both. Additionally, or alternatively, the CSIUC information may indicate a duration 320 (e.g., remaining COT duration) referenced from an offset 315 (e.g., the offset 315-a or the offset 315-b in the context of FIG. 4). In some cases, the duration 320 may be based on sidelink CAPC, priority, number of responders, or any combination. In some aspects, the duration 320 may contain a time segment with contiguous time resources (e.g., frames, subframes, or slots). In some aspects, the duration 320 may contain multiple time segments with contiguous time resources (e.g., frames, subframes, or slots) in each time segment. Additionally, or alternatively, the duration 320 may be aperiodic or periodic (e.g., with the period time interval configured or indicated in the CAIUC). Additionally, or alternatively, the CSIUC information may indicate a CPE 325 starting point, which may be based on sidelink CAPC, priority, random, or any combination. In some cases where the CPE starting point is not indicated in the CSIUC, UE 115-e, the UE 115-f, or both, may determine a CPE 325 starting point based on the sidelink CAPC, priority, or the like thereof, of the TB to be transmitted or randomly select a CPE 325 starting point.

FIG. 4 illustrates examples of frequency resource allocations 400 (e.g., a resource allocation 400-a, a resource allocation 400-b, and a resource allocation 400-c) that supports inter-UE coordination with COT sharing for sidelink in accordance with one or more aspects of the present disclosure. In some examples, the resource allocations 400 may implement or be implemented by aspects of the wireless communications system 100, the wireless communications system 200, and the time resource allocation 300. For example, the resource allocations 400 may be implemented by one or more network entities 105 and one or more UEs 115, which may be examples of the corresponding devices as described with reference to FIG. 1. The resource allocations 400 may support communication of CSIUC information associated with sharing a COT with multiple UEs 115 (e.g., using different frequency resource allocations).

As described previously, a first UE 115 may transmit (e.g., unicast, broadcast, or groupcast) one or more transmissions to one or more additional UEs 115, such as a second UE 115, a third UE 115, or both, including CSIUC information (e.g., a set of parameters) associated with sharing a COT. The CSIUC information may indicate time (e.g., remaining COT duration 320) and frequency resources (e.g., within RB sets 405) within the COT. For example, the CSIUC information may indicate preferred time and frequency resources, non-preferred time and frequency resources, or both.

In some examples, the CSIUC information may indicate a frequency resource allocation based on one or more RB sets 405, one or more subchannels 410, one or more interlaces 415, one or more starting points, or any combination thereof. For example, in a resource allocation 400-a, the CSIUC information may indicate an RB set 405-a (e.g., from the RB set 405-a, an RB set 405-b, and an RB set 405-c). In other example, such as an resource allocation 400-b, the CSIUC information may indicate an RB set 405-d, an RB set 405-e, and an RB set 405-f and, in a resource allocation 400-c, the CSIUC information may indicate an RB set 405-g, an RB set 405-h, and an RB set 405-i. In some cases, the CSIUC information may indicate one or more RB sets 405 via an RB set index, an RB set ID, or both.

Additionally, or alternatively, the CSIUC information may indicate one or more subchannels 410 within an RB set 405, across multiple RB sets 405, or both via a subchannel index, a subchannel ID, or both. In some aspects, in the resource allocation 400-a, the CSIUC information may indicate one or more subchannels indexed or identified across all RB sets, for example, a subchannel 410-a (e.g., subchannel 0) and a subchannel 410-b (e.g., subchannel 1) in the RB set 405-a (e.g., from a set of subchannels 410 including at least the subchannel 410-a, the subchannel 410-b, and a subchannel 410-c) or a subchannel 410-d and a subchannel 410-e in the RB set 405-b (e.g., from a set of subchannels 410 including at least the subchannel 410-d and the subchannel 410-e). In this case, one or more subchannels 410 may be uniquely indexed or identified across all RB sets 405 and thus the CSIUC may indicate frequency resources with a subchannel indication without explicitly indicating each RB set 405. In other aspects, such as in the frequency resource allocation 400-b, the CSIUC information may indicate one or more subchannels 410 indexed or identified within each RB set 405 of all RB sets 405, for example, the subchannel 410-a and the subchannel 410-b (e.g., for UE 115-b) within each RB set 405 of the RB set 405-d, the RB set 405-e, and the RB set 405-f or the subchannel 410-c (e.g., for UE 115-c) within each RB set 405 of the RB set 405-d, the RB set 405-e, and the RB set 405-f (e.g., within each RB set 405 of RB sets 405 including at least the RB set 405-d, the RB set 405-e, and the RB set 405-f). In this case, one or more subchannels 410 may be uniquely indexed or identified within an RB set 405 and thus the CSIUC may indicate frequency resources with subchannel indication without explicitly indicating each RB set 405 (e.g., one or more subchannels 410 in all RB sets 405) if all RB sets 405 have the same size or with explicitly indicating each RB set 405 (e.g., one or more subchannels 410 within an RB set 405) if all RB sets 405 have different sizes.

Additionally, or alternatively, in the frequency resource allocation 400-c, the CSIUC information may indicate one or more interlaces 415, such as an interlace 415-a (e.g., interlace 0) and an interlace 415-b (e.g., interlace 1). In some cases, the CSIUC information may indicate one or more interlaces 415 via an interlace index, an interlace ID, or both, for example, the interlace 415-a (e.g., for UE 115-b) and the interlace 415-b (e.g., for UE 115-c) within each RB set 405 of the RB set 405-g, the RB set 405-h, and the RB set 405-i (e.g., within each RB set 405 of RB sets 405 including at least the RB set 405-g, the RB set 405-h, and the RB set 405-i). In this case, one or more interlaces 415 may be uniquely indexed or identified within an RB set 405 and thus the CSIUC may indicate frequency resources with interlace indication without explicitly indicating each RB set 405 (e.g., one or more interlaces 415 in all RB sets 405) if all RB sets 405 have the same size or with explicitly indicating each RB set 405 (e.g., one or more interlaces 415 within an RB set 405) if all RB sets 405 have different sizes.

Additionally, or alternatively, the CSIUC information may indicate one or more starting points for frequency resources. For example, the CSIUC information may indicate a lowest RB index or ID within one or more RB sets 405, one or more subchannels 410, one or more interlaces 415, or any combination thereof, where the starting point is associated with the lowest RB index or lowest RB ID. Additionally, or alternatively, the CSIUC information may indicate a lowest subchannel index or ID or a lowest interlace index or ID associated with one or more RB sets 405, where the starting point is associated with the lowest subchannel index or ID or the lowest interlace index or ID.

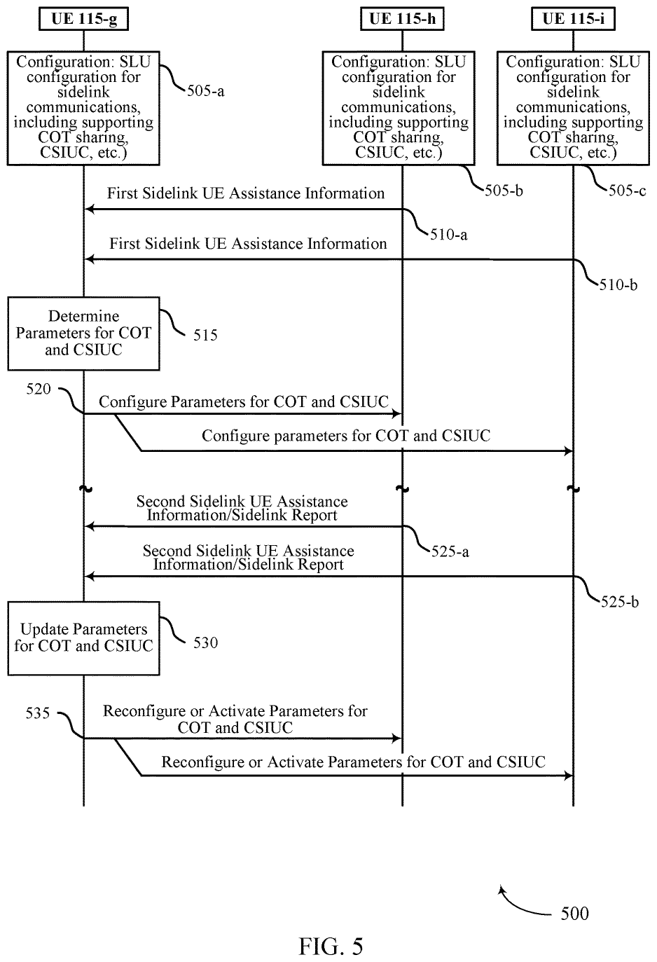

FIG. 5 illustrates an example of a process flow 500 that supports inter-UE coordination with COT sharing for sidelink in accordance with one or more aspects of the present disclosure. In some examples, the process flow 500 may implement or be implemented by aspects of the wireless communications system 100, the wireless communications system 200, the time resource allocation 300, and the frequency resource allocations 400. For example, the process flow 500 may include one or more network entities 105 and one or more UEs 115 (e.g., a UE 115-g, a UE 115-h, and a UE 115-i), which may be examples of the corresponding devices as described with reference to FIG. 1. The process flow 500 may illustrate an example of a configuration or activation of one or more parameters for enabling COT sharing and communication (e.g., transmission or reception) of CSIUC information.

In some examples, at 505-a, a UE 115-g (e.g., transmitter UE 115) may receive (e.g., may be pre-configured or configured with) a first sidelink unlicensed (SLU) configuration associated with (e.g., slu-config for a UE 115 supporting sidelink communications on unlicensed spectrum) one or more sidelink communications with one or more RB sets or LBT channels (e.g., 20 MHz each) and/or within one or more resource pools using a sidelink band width part (BWP) or a sidelink carrier, where the first SLU configuration supports COT sharing, communication of CSIUC information, or both. One or more additional UEs 115 (e.g., receiver UEs 115), such as a UE 115-h, a UE 115-i, or both, may receive (e.g., at 505-b and 505-c, respectively) respective SLU configurations, such as a second SLU configuration and a third SLU configuration, associated with the one or more sidelink communications, where the respective SLU configurations support COT sharing, communication of CSIUC information, or both (e.g., any combination of the first SLU configuration, the second SLU configuration, and the third SLU configuration may be a same SLU configuration or a different SLU configuration).

The SLU configuration may include indications of enabling or disabling COT sharing (e.g., enabling a UE 115 to initiate and/or resume and/or extend a COT to be shared with other UEs 115 with or without certain conditions, or enabling a UE 115 to share a COT initiated and/or resumed and/or extended with or without certain conditions) and related configuration for COT sharing with one or more RB sets or LBT channels (e.g., 20 MHz each) within one or more resource pools using a sidelink band width part (BWP) or a sidelink carrier. In some aspects, a COT sharing configuration may include one or more COT time durations and/or frequency ranges (e.g., one or RB sets or LBT channels for a COT) associated with sidelink CAPCs, priorities, or both, one or more CPE starting points (e.g., within symbol(s) of a slot) for LBT operation sharing the COT. In some aspects, a COT sharing configuration may include one or more conditions for enabling or disabling COT to be shared or for enabling or disabling a COT to be resumed or extended with a sidelink transmission based on at least one of the signal or channel of the sidelink transmission (e.g., an S-SSB or PSFCH or PSCCH and/or PSSCH transmission), the sidelink CAPC or priority or PDB or remaining PDB associated to the sidelink transmission (e.g., a sidelink transmission with sidelink CAPC or priority or PDB or remaining PDB value below a threshold pre-configured or configured), the cast type associated to the sidelink transmission (e.g., a TB transmission with a unicast, groupcast or broadcast), or the communication range associated to the sidelink transmission (e.g., COT sharing within a certain distance from the UE initiating, resuming or extending a COT).

The SLU configuration may include indication of enabling or disabling CSIUC for CSIUC operation on sharing a COT and related configuration for CSIUC operation with one or more RB sets or LBT channels (e.g., 20 MHz each) within one or more resource pools using a sidelink band width part (BWP) or a sidelink carrier. In some aspects, a CSIUC configuration may include the type of resources indicated in the CSIUC (e.g., preferred (to share) or non-preferred (blocked for sharing) or both), the condition triggering a CSIUC transmission (e.g., LBT performance such as LBT success or failure rate or sidelink consecutive LBT failure count, channel condition such as CBR measurements, number of responders, cast type, etc.), the condition for validating a responder to share a COT, the communication range for CSIUC, etc. In some aspects, a CSIUC configuration may include the signaling for a CSIUC (e.g., a CSIUC transmitted on SCI, such as SCI part 2, or on a MAC-CE).

At step 510 (e.g., step 510-a, step 510-b, or both), the UE 115-h, the UE 115-i, or both, may transmit first sidelink UE assistance information to the UE 115-g.

The first sidelink UE assistance information may include information associated with SLU operations, including, at least, one or more preferred parameters associated with a COT sharing configuration, one or more preferred parameters associated with CSIUC configuration, or both, as described in detail at step 505. The one or more preferred parameters associated with the COT sharing configuration, the one or more preferred parameters associated with CSIUC configuration, or both, may include an indication of supporting COT sharing or COT extension or CSIUC operation, an indication of supporting multi-slot consecutive transmissions, a sync-ref UE 115 (e.g., transmitting S-SSB), a UE identifier, a UE capability of processing CSIUC information (e.g., minimum time gap from receiving a CSIUC to sharing the COT based on the received CSIUC information), CSIUC carried on MAC-CE or SCI 2, or any combination thereof.

At 515, the UE 115-g may determine one or more parameters associated with the COT (e.g., one or more parameter values for the COT), one or more parameters associated with the CSIUC information (e.g., one or more parameter values for the CSIUC information), or both, based on the COT sharing configuration, CSIUC configuration, and/or the first sidelink UE assistance information.

At 520, the UE 115-g may transmit an indication of (e.g., an activation or deactivation message indicating) the determined one or more parameter values associated with COT sharing, the determined one or more parameter values associated with CSIUC operation, or both, to the UE 115-h, the UE 115-i, or both (e.g., may configure the determined parameter values). That is, the UE 115-g may activate the determined one or more parameter values associated with COT sharing (e.g., enabling COT sharing resume or extension or not, enabling COT sharing for broadcast/groupcast or not), the determined one or more parameter values associated with CSIUC operation (e.g., CSIUC carried on SCI 2 or MAC-CE), or both (e.g., the activation or the deactivation message may be a PC5 MAC-CE).

At 525 (e.g., step 525-a, step 525-b, or both), the UE 115-h, the UE 115-i, or both, may transmit second sidelink UE assistant information, one or more sidelink reports, or both, including information associated with the SLU operations (e.g., performed by the UE 115-h, the UE 115-i, or both), including, at least an LBT success rate, an LBT failure rate, a quantity (e.g., count) of consecutive LBT failures, or including channel condition associated with sidelink traffic, including, at least an CBR measurement, or the like thereof.

At 530, the UE 115-g may update the one or more parameters (e.g., one or more parameter values) associated with the COT sharing, the one or more parameter values associated with the CSIUC operation, or both, based on the second sidelink UE assistance information or sidelink reports.

At 535, the UE 115-g may transmit an indication of (e.g., configuration or reconfiguration message indicating) the updated one or more parameters associated with the COT sharing, the one or more updated parameters associated with the CSIUC operation, or both, to the UE 115-h, the UE 115-i, or both (e.g., may configure the updated parameter values). That is, the UE 115-g may reconfigure or activate one or more parameters associated with the COT sharing, the one or more updated parameters associated with the CSIUC operation, or both (e.g., the configuration or the reconfiguration message may be message may be a PC5 RRC message such as RRCReconfigurationSidelink, the activation or deactivation message may be a PC5 MAC-CE).

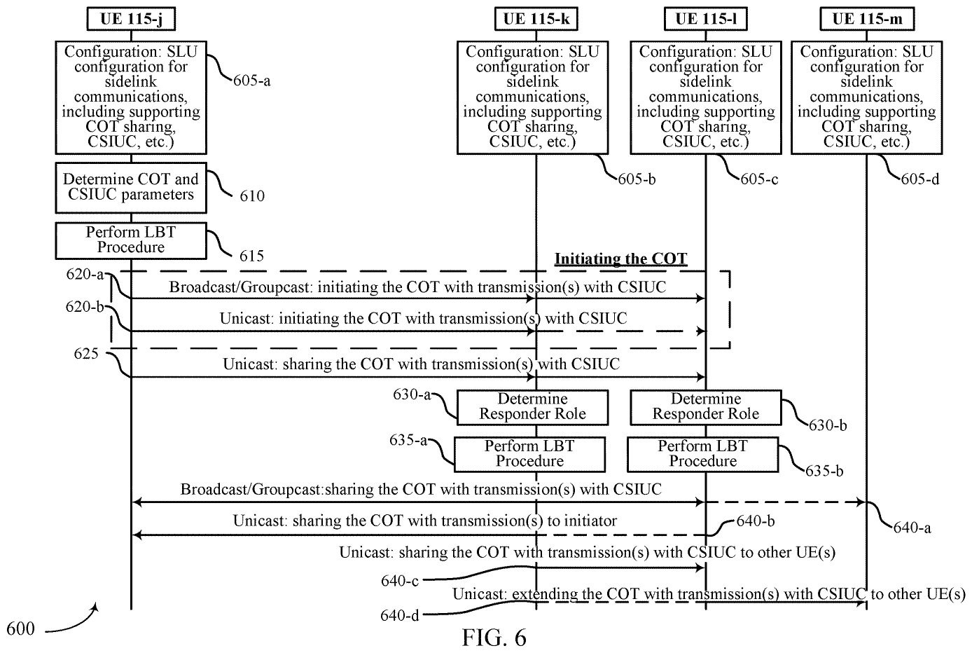

FIG. 6 illustrates an example of a process flow 600 that supports inter-UE coordination for COT sharing for sidelink in accordance with one or more aspects of the present disclosure. In some examples, the process flow 600 may implement or be implemented by aspects of the wireless communications system 100, the wireless communications system 200, the time resource allocation 300, the resource allocations 400, and the process flow 500. For example, the process flow 600 may include one or more network entities 105 and one or more UEs 115 (e.g., a UE 115-j, a UE 115-k, a UE 115-l, and a UE 115-m), which may be examples of the corresponding devices as described with reference to FIG. 1. The process flow 600 may illustrate an example operations associated with CSIUC information.

In some examples, at 605-a, a UE 115-j (e.g., a transmitter UE 115) may receive (e.g., may be pre-configured or configured with) an SLU configuration associated with sidelink communication, where the SLU configuration indicate one or more parameters associated with (e.g., for) COT sharing, one or more parameters associated with communicating CSIUC information, or both, as described in detail in FIG. 5. Similarly, one or more additional UEs 115 (e.g., receiver UEs 115), such as a UE 115-k, a UE 115-l, the UE 115-m, or any combination thereof, may receive (e.g., at 505-b, 505-c, and 505-d, respectively) respective SLU configurations for the sidelink communication, where the respective SLU configurations indicate the one or more parameters associated with (e.g., for) the COT sharing, the one or more parameters associated with communicating the CSIUC information, or both. That is, the UEs 115 may be configured or activated (e.g., by one or more network entities 105 or by a UE 115 as described in FIG. 5) with the one or more parameters associated with the COT sharing, the one or more parameters associated with the CSIUC operation, or both. In some examples, one or more of the UEs 115 (e.g., the UE 115-j, the UE 115-k, the UE 115-l, the UE 115-m) may be associated with a same SLU configuration.

At 610, the UE 115-j may determine one or more transport blocks (TBs) for transmission (e.g., to transmit to one or more of the additional UEs 115). Additionally, the UE 115-j may determine one or more COT parameters, one or more CSIUC parameters (e.g., CSIUC information), or both, to be transmitted to the UE 115-k, the UE 115-l, or both. In some examples, the UE 115-j may determine the one or more COT parameters, the one or more CSIUC parameters, or both, based on a quality of service (QOS), sidelink CAPC or priority associated with the one or more TBs, a cast type associated with the one or more TBs, or both.

At 615, the UE 115-j may perform an LBT procedure associated with transmitting the one or more TBs (e.g., the UE 115-j may conduct a full scale LBT for accessing a channel to transmit the one or more TBs).

At 620, the UE 115-j may initiate a COT (e.g., with a COT indication) via one or more first transmissions (e.g., for the one or more TBs, where the one or more first transmissions include one or more CSIUC information). For example, the UE 115-j (e.g., a COT initiator) may transmit one or more first sidelink messages initiating the COT via the one or more first sidelink messages, including a COT indication with at least a first set of CSIUC parameters (e.g., CSIUC information) associated with the COT being shared with at least the UE 115-k, the UE 115-l, or both. The first set of CSIUC parameters may indicate time and frequency resources within the shared COT. Additionally, or alternatively, the first set of CSIUC parameters may include one or more offsets, one or more durations, one or more starting points, one or more resource block sets, one or more subchannels, one or more interlaces, or any combination thereof, associated with the time and frequency resources. Additionally, or alternatively, the first set of CSIUC parameters may include one or more UE identifiers, one or more destination identifiers, one or more priorities, one or more CAPCs, one or more communication ranges, or any combination thereof, for sharing the COT.

In some examples, the time and frequency resources may be allocated to the UE 115-k, the UE 115-l, or both. That is, the time and frequency resources may be preferred resources (e.g., for COT sharing). Alternatively, the time and frequency resources may be restricted from use by the UE 115-k, the UE 115-l, or both. That is, the time and frequency resources may be non-preferred resources. Additionally, or alternatively,

In some examples (e.g., at 620-a), the UE 115-j may broadcast or groupcast the one or more first transmissions (e.g., the one or more first sidelink messages) initiating the COT to multiple UEs 115, such as the UE 115-k, the UE 115-l, or both. In some aspects, one or more first sets of CSIUC parameters (e.g., one or more CSIUC information) may be transmitted with a broadcast or groupcast transmission associated to a destination ID. For example, the one or more first sets of CSIUC parameters may be indicated via first CSIUC information with preferred resources, non-preferred resources, or both, for one or more first UEs 115 (e.g., the UE 115-k, the UE 115-l, or both) determined by one or more first UE IDs (e.g., individual UE IDs for the one or more first UEs 115) or a group ID (e.g., a destination ID of broadcast or groupcast) for the one or more first UEs 115) indicated in the first CSIUC information (e.g., explicit indication of the one or more UEs) or a first communication range configured, activated, or indicated in the first CSIUC information (e.g., implicit indication of the one or more UEs 115, for example, one or more UEs with a first communication range). Additionally, or alternatively, the one or more first sets of CSIUC parameters may be indicated via second CSIUC information with preferred resources, non-preferred resources, or both, for one or more second UEs 115 determined by one or more second UE IDs indicated in the second CSIUC information or a second communication range configured, activated, or indicated in the second CSIUC information.

In some aspects, the one or more first sets of CSIUC parameters (e.g., one or more CSIUC information) may be transmitted with one or more broadcast or groupcast transmissions associated with a same or different destination IDs associated with the same or different sidelink communications. For example, the one or more first sets of CSIUC parameters may be indicated via first CSIUC information with preferred resources, non-preferred resources, or both, for at least one or more first UEs 115 (e.g., the UE 115-k, the UE 115-l, or both) determined by one or more first UE IDs indicated in the first CSIUC information or a first communication range configured, activated, or indicated in the first CSIUC information or a first destination ID associated to a first broadcast or groupcast or a first sidelink communication. Additionally, or alternatively, the one or more first sets of CSIUC parameters may be indicated via second CSIUC information with preferred resources, non-preferred resources, or both, for at least one or more second UEs 115 (e.g., the UE 115-k, the UE 115-l, or both) determined by one or more second UE IDs indicated in the second CSIUC information or a second communication range configured, activated, or indicated in the second CSIUC information or a second destination ID associated to a second broadcast or groupcast or a second sidelink communication. For multiple broadcast or groupcast transmissions associated with a same destination ID (multiple transmissions for a sidelink communication), one or more CSIUC information indications may be transmitted with any of multiple broadcast or groupcast transmissions (e.g., based on received UE 115 capability of processing CSIUC information, for example, CSIUC transmitted with the first transmission for UEs 115 with long CSIUC processing time or CSIUC transmitted with the last transmission for UEs 115 with short CSIUC processing time).

Additionally, or alternatively (e.g., at 620-b), the UE 115-j may unicast the one or more first transmission (e.g., the one or more first sidelink messages) initiating the COT to the UE 115-k, the UE 115-l, or both. For example, the UE 115-j may unicast a first transmission of the one or more first transmissions to the UE 115-k (e.g., the UE 115-k is identified by the destination ID of the first transmission) with first CSIUC information for the UE 115-k (e.g., identified by the destination ID of the first transmission) and unicast a second transmission of the one or more first transmissions to the UE 115-k (e.g., multiple transmissions such as multi-slot consecutive transmissions of a sidelink communication to a same UE 115 identified by the same destination ID of the first transmission or second transmission) with or without second CSIUC information (e.g., if transmitted, the second CSIUC information may be different from the first CSIUC information with the preferred resources, non-preferred resources, or both) for the UE 115-k. In this case, the CSIUC may not include a UE ID. In another examples, the UE 115-j may unicast the first transmission of the one or more first transmissions to the UE 115-k (e.g., the UE 115-k is identified by the destination ID of the first transmission) with first CSIUC information to the UE 115-k (e.g., identified by the destination ID of the first transmission) and unicast a second transmission of the one or more first transmissions to the UE 115-l (e.g., different UEs 115 identified by the destination ID of the second transmission) with second CSIUC information to the UE 115-l (e.g., identified by the destination ID of the second transmission). In this case, the CSIUC may not include a UE ID. Additionally, the first transmission to UE 115-k and the second transmission to UE 115-l may be based on UE 115 CSIUC processing time (e.g., the first transmission with the first CSIUC to the UE 115-k may provide longer time for the UE 115-k to process the first CSIUC information). In another examples, the UE 115-j may unicast the first transmission of the one or more first transmissions to the UE 115-k (e.g., the UE 115-k is identified by the destination ID of the first transmission) without CSIUC information for the UE 115-k (e.g., identified by the destination ID of the first transmission) and unicast a second transmission of the one or more first transmissions to the UE 115-l (e.g., different UEs 115 identified by the destination ID of the second transmission) with first CSIUC information for the UE 115-k and second CSIUC information for the UE 115-l. In this case, the first CSIUC information may include a first UE ID associated with the UE 115-l and the second CSIUC information may include a second UE ID associated with the UE 115-k. In another examples, the UE 115-j may unicast the first transmission of the one or more first transmissions to the UE 115-k (e.g., the UE 115-k is identified by the destination ID of the first transmission) without CSIUC information for the UE 115-k (e.g., identified by the destination ID of the first transmission) and unicast a second transmission of the one or more first transmissions to the UE 115-l (e.g., different UEs 115 identified by the destination ID of the second transmission) with first CSIUC information including an indication of first preferred resources or first non-preferred resources associated with the UE 115-k and second preferred resources or second non-preferred resources associated with the UE 115-l. In this case, the first CSIUC information may include a first UE ID associated with the UE 115-l and a second UE ID associated with the UE 115-k.

At 625, the UE 115-j may transmit one or more second transmissions (e.g., one or more second sidelink messages) within the shared COT (e.g., sharing the COT with the one or more second transmissions for the one or more TBs transmitted to one or more other Rx UEs 115 via unicast, groupcast or broadcast). In some cases, the one or more second transmissions may include an additional set of CSIUC parameters (e.g., additional CSIUC information) associated with sharing the COT, where the additional set of CSIUC parameters (e.g., the additional CSIUC information) indicate second time and frequency resources (e.g., preferred resources, non-preferred resources, or both) within the shared COT. In some aspects, the one or more second transmissions from the UE 115-j (e.g., the COT initiator) may be transmitted to same receiving UE(s) 115 as the one or more first transmissions (e.g., the UE 115-k, the UE 115-l, or both) without CSIUC information. In this case, the CSIUC information transmitted with the one or more first transmissions may be considered by the same receiving UE(s) 115 (e.g., the same COT responder(s)) if the preferred resources or the non-preferred resources are still applicable. In some aspects, the one or more second transmissions from the UE 115-j (e.g., the COT initiator) may be transmitted to the same receiving UE(s) 115 as the one or more first transmissions (e.g., the UE 115-k, the UE 115-l, or both) with additional CSIUC information. In this case the additional CSIUC information transmitted with the one or more second transmissions may be considered by the same receiving UE(s) 115 (e.g., the same COT responder(s)). Additionally, or alternatively, the UE 115-j (e.g., the COT initiator) may resume the COT sharing with the same receiving UE(s) 115 (e.g., same responder(s), such as the UE 115-k, the UE 115-l, or both) with a COT indication, additional CSIUC information, or both. In some aspects, the one or more second transmissions from the UE 115-j (e.g., the COT initiator) may be transmitted to different receiving UE(s) 115 from the one or more first transmissions with additional CSIUC information. In this case the additional CSIUC information transmitted with the one or more second transmissions may be considered by the different receiving UE(s) 115 (e.g., the different COT responder(s)). Additionally, or alternatively, the UE 115-j (e.g., the COT initiator) may extend the COT sharing with different receiving UE(s) 115 (e.g., different responder(s) via different IDs) with a COT indication, additional CSIUC information, or both.

At 630 (e.g., 630-a, 630-b, or both), the UE 115-k, the UE 115-l, or both, may determine respective responder roles based on a destination ID (e.g., associated with a received transmission of the one or more first transmissions or the one or more second transmissions), a UE identifier (e.g., indicated in the first CSIUC information received with the one or more first transmissions or the second CSIUC information received with the one or more second transmissions), the COT initiator ID (e.g., the transmitter UE identifier for the transmission with COT indication or CSIUC, for example, the layer 1 or 2 source ID of the transmission with the COT indication or CSIUC, which may be used for determining respective responder role for COT sharing with a responding transmissions to the COT initiator), or any combination thereof. Additionally, the UE 115-k, the UE 115-l, or both, may determine third time and frequency resources within the COT based on the first set of CSIUC parameters (e.g., the first CSIUC information indicating the first preferred time and frequency resources, the first non-preferred time and frequency resources, or both), the second set of CSIUC parameters (e.g., the second CSIUC information indicting the second preferred time and frequency resources, the second non-preferred time and frequency resources, or both), or both. For example, the UE 115-k may validate a destination identifier associated with the one or more first transmissions matches a first identifier associated with the UE 115-k (e.g., the destination identifier associated with the one or more first transmissions matches a first identifier, such as a layer 1 or 2 source ID, at the UE 115-k as a receiving UE 115 for a unicast transmission or matches a first identifier, such as a layer 1 or 2 destination ID, at the UE 115-k as a receiving UE 115 for a broadcast or a groupcast transmission). Additionally, or alternatively, the UE 115-l may validate a first UE identifier of the one or more UE identifiers (e.g., indicated in the CSIUC information) matches a second identifier (e.g., same as or different than the first identifier) associated with the UE 115-l (e.g., the first UE identifier indicated in a CSIUC information matches a UE's identifier, for example, an identifier associated with the UE 115-l, indicated in the sidelink UE assistance information as described in FIG. 5, or matches an identifier associated with the UE 115-l as a paired UE 115 for unicast).

Additionally, or alternatively, the UE 115-k, the UE 115-l, or both, may determine respective responder roles based on a destination ID (e.g., associated with a received transmission of the one or more first transmissions or the one or more second transmissions), a UE identifier (e.g., indicated in the first CSIUC information received with the one or more first transmissions or in the second CSIUC information received with the one or more second transmissions), a communication range (e.g., based on the configuration or activation as described in FIG. 5 or based on the indication in the first CSIUC information received with the one or more first transmissions or the second CSIUC information received with the one or more second transmissions), or a combination thereof. Additionally, the UE 115-k, the UE 115-l, or both, may determine third time and frequency resources within the COT based on the first set of CSIUC parameters (e.g., the first CSIUC information indicating the first preferred time and frequency resources, the first non-preferred time and frequency resources, or both), the second set of CSIUC parameters (e.g., the second CSIUC information indicating the second preferred time and frequency resources, the second non-preferred time and frequency resources, or both), or both. For example, with matched destination ID, the UE 115-k, the UE 115-l, or both, may determine respective responder roles if the distance from the COT initiator is within the communication range as configured, activated, or indicated in the received CSIUC information. For another example, with matched UE identifier, the UE 115-k, the UE 115-l, or both, may determine respective responder roles if the distance from the COT initiator is within the communication range as configured, activated, or indicated in the received CSIUC information.

As such, the UE 115-k may select the third time and frequency resources based on the first (e.g., received with the one or more first transmissions at 620) or second (e.g., received with the one or more second transmissions at 625) set of CSIUC parameters. In some examples, the third time and frequency resources may be a subset of the first time and frequency resources based on the first or second time and frequency resources being preferred time and frequency resources. In such cases, the UE 115-k may select the subset of the first or second time and frequency resources randomly or based on measuring a channel associated with the COT over the first or second time and frequency resources (e.g., based on full sensing or partial sensing). Alternatively, the third time and frequency resources may be outside of the first or second time and frequency resources based on the first or second time and frequency resources being non-preferred time and frequency resources

In some cases, at 635 (e.g., at 635-a, 635-b, or both), the UE 115-k, the UE 115-l, or both, may conduct an LBT procedure based on the COT sharing (e.g., type 2 LBT procedure).

Additionally, at 640, the UE 115-k, the UE 115-l, or both, may communicate one or more third transmissions (e.g., one or more third sidelink messages) based on the COT sharing and the first set of CSIUC parameters (e.g., the first CSIUC information receive with the one or more first transmissions), the second set of CSIUC parameters (e.g., the second CSIUC information receive with the one or more second transmissions), or both. For example, (e.g., at 640-a), the UE 115-k, the UE 115-l, or both, may broadcast or groupcast the one or more third transmission sharing the COT to other UEs 115 (e.g., some of the other UEs 115, such as UE 115-m, may not be receiving UEs 115 of the one or more first transmissions or the one or more second transmissions from the UE 115-j as the COT initiator), including the UE 115-j.

Additionally, or alternatively (e.g., at 640-b), the UE 115- k, the UE 115-l, or both, may unicast the one or more third transmissions sharing the COT to the UE 115-j (e.g., one or more HARQ feedbacks on PSFCH transmission(s), one or more CSI reports on PSSCH transmission(s), or one or more TB transmissions). In such cases, the UE 115-j may receive the one or more third transmissions based on a destination identifier associated with the one or more third transmissions matching an identifier associated with the UE 115-j (e.g., the source ID of the transmission 620-a, 620-b or 625). Additionally, or alternatively (e.g., at 640-c), the UE 115-k, the UE 115-l, or both, may unicast the one or more third transmissions sharing the COT to one or more other responder UEs 115 (e.g., the UE 115-k transmitting to the UE 115-l, where both UEs 115 are receiving UEs 115 of the one or more first transmissions or the one or more second transmissions, or are responders for sharing the COT initiated, resumed, or extended by the UE 115-j as the COT initiator) if the UE 115-k, the UE 115-l, or both, are allowed to extend the COT sharing with the other responder UEs 115, based on the enabling COT extension indication in the COT sharing configuration, reconfiguration, or activation with COT sharing parameters (e.g., as described with reference to FIG. 5 or indicated in the received CSIUC information).

Additionally, or alternatively (e.g., at 640-d), the UE 115-k, the UE 115-l, or both, may unicast the one or more third transmission extending the COT by the UE 115-k, the UE 115-l, or both, respectively, to one or more other UEs 115, such as the UE 115-m. The UE 115-m may not be receiving a UE 115 for the one or more first transmissions, from the UE 115-j, initiating the COT or for the one or more second transmissions, from the UE 115-j, sharing the COT if the UE 115-k, the UE 115-l, or both are allowed to extend the COT sharing with the other UEs 115, such as UE 115-m, based on the enabling COT extension indication in the COT sharing configuration, reconfiguration, or activation with COT sharing parameters (e.g., as described with reference to FIG. 5 or indicated in the received CSIUC information). In this case, the one or more third transmissions may include a COT indication, additional CSIUC information, or both, for extending the COT with other UEs 115, such as the UE 115-m.

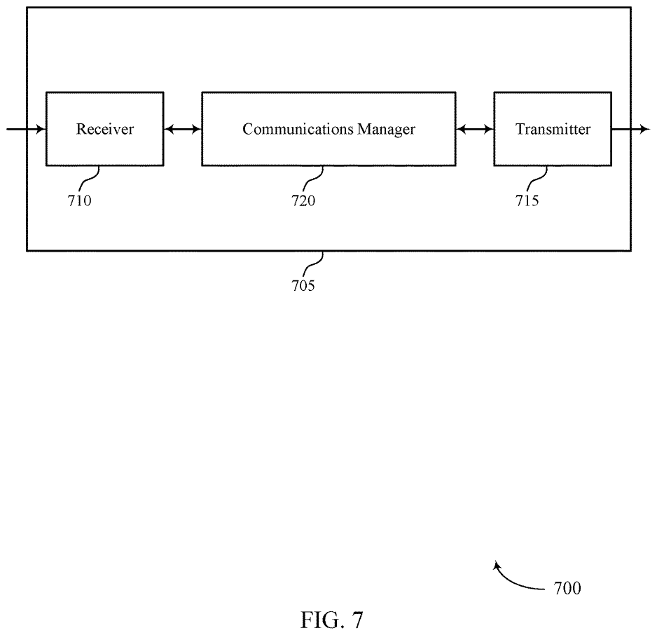

FIG. 7 illustrates a block diagram 700 of a device 705 that supports inter-UE coordination with COT sharing for sidelink in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to inter-UE coordination with COT sharing for sidelink). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to inter-UE coordination with COT sharing for sidelink). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of inter-UE coordination with COT sharing for sidelink as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a first UE in accordance with examples as disclosed herein. For example, the communications manager 720 may be configured as or otherwise support a means for transmitting one or more first sidelink messages initiating a COT, the one or more first sidelink messages including a first set of parameters associated with the COT being shared with at least a second UE, a third UE, or both, where the first set of parameters indicate time and frequency resources within the shared COT. The communications manager 720 may be configured as or otherwise support a means for receiving, from the second UE, the third UE, or both, one or more second sidelink messages during the shared COT in response to transmitting the one or more first sidelink messages.

Additionally, or alternatively, the communications manager 720 may support wireless communications at a first UE in accordance with examples as disclosed herein. For example, the communications manager 720 may be configured as or otherwise support a means for receiving, from a second UE, one or more first sidelink messages initiating a COT, the one or more first sidelink messages including a first set of parameters associated with the COT being shared with at least a second UE, a third UE, or both, where the first set of parameters indicate time and frequency resources within the shared COT. The communications manager 720 may be configured as or otherwise support a means for transmitting one or more second sidelink messages during the shared COT in response to receiving the one or more first sidelink messages.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for inter-UE coordination with COT sharing for sidelink which may result in reduced processing, reduced power consumption, and more efficient utilization of communication resources, among other advantages.

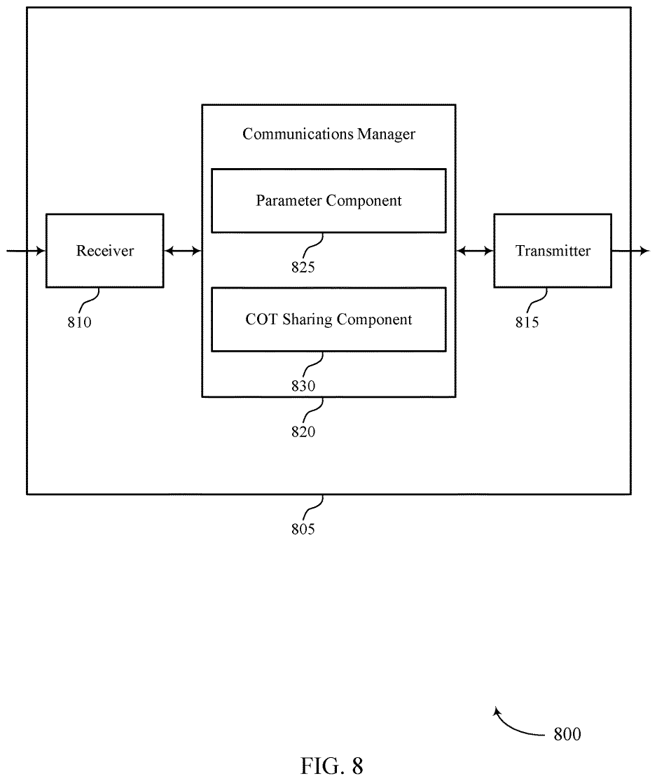

FIG. 8 illustrates a block diagram 800 of a device 805 that supports inter-UE coordination with COT sharing for sidelink in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to inter-UE coordination with COT sharing for sidelink). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to inter-UE coordination with COT sharing for sidelink). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of inter-UE coordination with COT sharing for sidelink as described herein. For example, the communications manager 820 may include a parameter component 825 a COT sharing component 830, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a first UE in accordance with examples as disclosed herein. The parameter component 825 may be configured as or otherwise support a means for transmitting one or more first sidelink messages initiating a COT, the one or more first sidelink messages including a first set of parameters associated with the COT being shared with at least a second UE, a third UE, or both, where the first set of parameters indicate time and frequency resources within the shared COT. The COT sharing component 830 may be configured as or otherwise support a means for receiving, from the second UE, the third UE, or both, one or more second sidelink messages during the shared COT in response to transmitting the one or more first sidelink messages.

Additionally, or alternatively, the communications manager 820 may support wireless communications at a first UE in accordance with examples as disclosed herein. The parameter component 825 may be configured as or otherwise support a means for receiving, from a second UE, one or more first sidelink messages initiating a COT, the one or more first sidelink messages including a first set of parameters associated with the COT being shared with at least a second UE, a third UE, or both, where the first set of parameters indicate time and frequency resources within the shared COT. The COT sharing component 830 may be configured as or otherwise support a means for transmitting one or more second sidelink messages during the shared COT in response to receiving the one or more first sidelink messages.

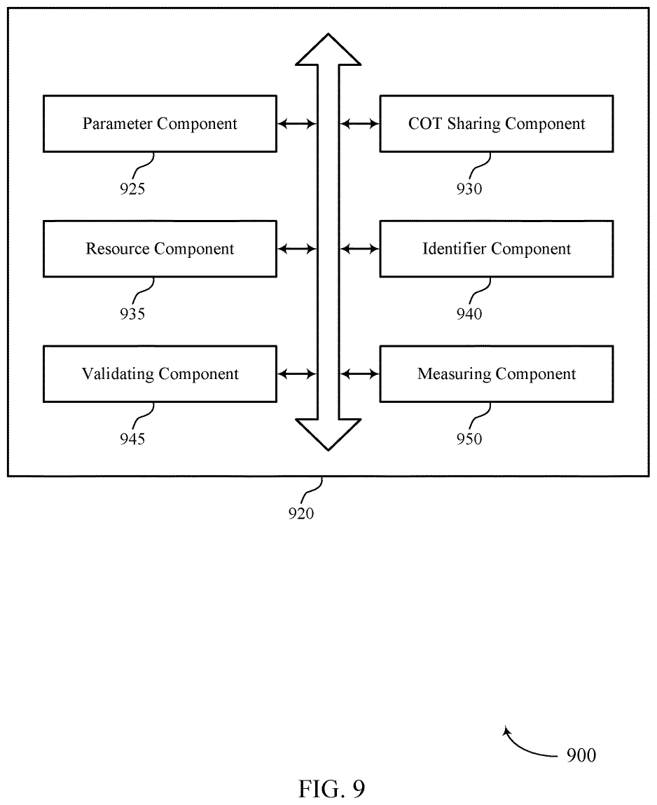

FIG. 9 illustrates a block diagram 900 of a communications manager 920 that supports inter-UE coordination with COT sharing for sidelink in accordance with one or more aspects of the present disclosure. The communications manager 920 may be an example of aspects of a communications manager 720, a communications manager 820, or both, as described herein. The communications manager 920, or various components thereof, may be an example of means for performing various aspects of inter-UE coordination with COT sharing for sidelink as described herein. For example, the communications manager 920 may include a parameter component 925, a COT sharing component 930, a resource component 935, an ID component 940, a validating component 945, a measuring component 950, or any combination thereof. Each of these components may communicate, directly or indirectly, with one another (e.g., via one or more buses).

The communications manager 920 may support wireless communications at a first UE in accordance with examples as disclosed herein. The parameter component 925 may be configured as or otherwise support a means for transmitting one or more first sidelink messages initiating a COT, the one or more first sidelink messages including a first set of parameters associated with the COT being shared with at least a second UE, a third UE, or both, where the first set of parameters indicate time and frequency resources within the shared COT. The COT sharing component 930 may be configured as or otherwise support a means for receiving, from the second UE, the third UE, or both, one or more second sidelink messages during the shared COT in response to transmitting the one or more first sidelink messages.

In some examples, to support receiving the one or more second sidelink messages, the resource component 935 may be configured as or otherwise support a means for receiving the one or more second sidelink messages via at least a subset of the time and frequency resources based on the time and frequency resources being allocated to the second UE, the third UE, or both.

In some examples, to support receiving the one or more second sidelink messages, the resource component 935 may be configured as or otherwise support a means for receiving the one or more second sidelink messages outside of the time and frequency resources based on the time and frequency resources being restricted from use by the second UE, the third UE, or both.

In some examples, to support transmitting the one or more first sidelink messages initiating the COT, the parameter component 925 may be configured as or otherwise support a means for unicasting, broadcasting, or groupcasting, the one or more first sidelink messages.

In some examples, to support unicasting the one or more first sidelink messages initiating the COT, the parameter component 925 may be configured as or otherwise support a means for unicasting a third sidelink message of the one or more first sidelink messages to the second UE or the third UE. In some examples, to support unicasting the one or more first sidelink messages initiating the COT, the parameter component 925 may be configured as or otherwise support a means for unicasting a fourth sidelink message of the one or more first sidelink messages to the second UE or the third UE.

In some examples, the parameter component 925 may be configured as or otherwise support a means for transmitting a fifth sidelink message sharing the COT, the fifth sidelink message including a second set of parameters associated with the shared COT, where the second set of parameters indicate second time and frequency resources within the shared COT. In some examples, the COT sharing component 930 may be configured as or otherwise support a means for receiving one or more sixth sidelink messages during the shared COT based on the second set of parameters.

In some examples, the COT is shared with at least the second UE, the third UE, a fourth UE, or any combination thereof. In some examples, the one or more sixth sidelink messages are received from the second UE, the third UE, or the fourth UE, or combination thereof.

In some examples, to support receiving the one or more second sidelink messages, the ID component 940 may be configured as or otherwise support a means for receiving, from the second UE or the third UE, the one or more second sidelink messages based on a first ID associated with the time and frequency resources matching a second ID associated with the second UE or the third UE, respectively, where the first set of parameters includes the first ID.

In some examples, the first ID is a UE ID or a destination ID.

In some examples, the one or more first sidelink messages indicate a third set of parameters associated with third time and frequency resources within the COT, and the ID component 940 may be configured as or otherwise support a means for receiving, from the second UE or the third UE, the one or more second sidelink messages based on a third ID associated with the third time and frequency resources matching a fourth ID associated with the second UE or the third UE, respectively, where the third set of parameters includes the third ID.

In some examples, the first set of parameters includes one or more offsets, one or more durations, one or more starting points, one or more RB sets, one or more subchannels, one or more interlaces, or any combination thereof, associated with the time and frequency resources.

In some examples, the first set of parameters includes one or more UE IDs, one or more destination IDs, one or more priorities, one or more channel access priority classes, or any combination thereof.

In some examples, to support receiving the one or more second sidelink messages, the ID component 940 may be configured as or otherwise support a means for receiving the one or more second sidelink messages based on a destination ID associated with the one or more second sidelink messages matching an IDs associated with the first UE.

Additionally, or alternatively, the communications manager 920 may support wireless communications at a first UE in accordance with examples as disclosed herein. In some examples, the parameter component 925 may be configured as or otherwise support a means for receiving, from a second UE, one or more first sidelink messages initiating a COT, the one or more first sidelink messages including a first set of parameters associated with the COT being shared with at least a second UE, a third UE, or both, where the first set of parameters indicate time and frequency resources within the shared COT. In some examples, the COT sharing component 930 may be configured as or otherwise support a means for transmitting one or more second sidelink messages during the shared COT in response to receiving the one or more first sidelink messages.

In some examples, to support transmitting the one or more second sidelink messages, the resource component 935 may be configured as or otherwise support a means for transmitting the one or more second sidelink messages via at least a subset of the time and frequency resources based on the time and frequency resources being allocated to at least the first UE.

In some examples, the resource component 935 may be configured as or otherwise support a means for selecting the subset of the time and frequency resources based on the time and frequency resources being allocated to at least the first UE.

In some examples, the subset of the time and frequency resources are selected randomly.

In some examples, the measuring component 950 may be configured as or otherwise support a means for measuring a channel associated with the COT over the time and frequency resources, where selecting the subset of the time and frequency resources is based on the measuring.

In some examples, to support transmitting the one or more second sidelink messages, the resource component 935 may be configured as or otherwise support a means for transmitting the one or more second sidelink messages outside of the time and frequency resources based on the time and frequency resources being restricted from use by at least the first UE.

In some examples, the parameter component 925 may be configured as or otherwise support a means for receiving a third sidelink message sharing the COT, the third sidelink message including a second set of parameters associated with the shared COT, where the second set of parameters indicate second time and frequency resources within the shared COT. In some examples, the COT sharing component 930 may be configured as or otherwise support a means for transmitting one or more fourth sidelink messages during the shared COT based on the second set of parameters.

In some examples, to support transmitting the one or more second sidelink messages, the ID component 940 may be configured as or otherwise support a means for transmitting the one or more second sidelink messages based on a first ID associated with the time and frequency resources matching an second ID associated with the first UE, where the first set of parameters includes the first ID.

In some examples, the validating component 945 may be configured as or otherwise support a means for validating the first ID associated with the time and frequency resources matches the second ID associated with the first UE.

In some examples, the first ID is a UE ID or a destination ID.

In some examples, the first set of parameters includes one or more offsets, one or more durations, one or more starting points, one or more RB sets, one or more subchannels, one or more interlaces, or any combination thereof, associated with the time and frequency resources.

In some examples, the first set of parameters includes one or more UE IDs, one or more destination IDs, one or more priorities, one or more channel access priority classes, or any combination thereof.

In some examples, the parameter component 925 may be configured as or otherwise support a means for transmitting, to a fourth UE, a fifth sidelink message sharing the channel occupancy time with at least the second UE and the fourth UE, wherein the channel occupancy time is not initially shared with the fourth UE by the second UE, wherein the fifth sidelink message includes a third set of parameters associated with the share channel occupancy time, and wherein the third set of parameters indicate third time and frequency resources within the shared channel occupancy time.

In some examples, the one or more second sidelink messages includes an indication of a destination ID matching an ID associated with the second UE.

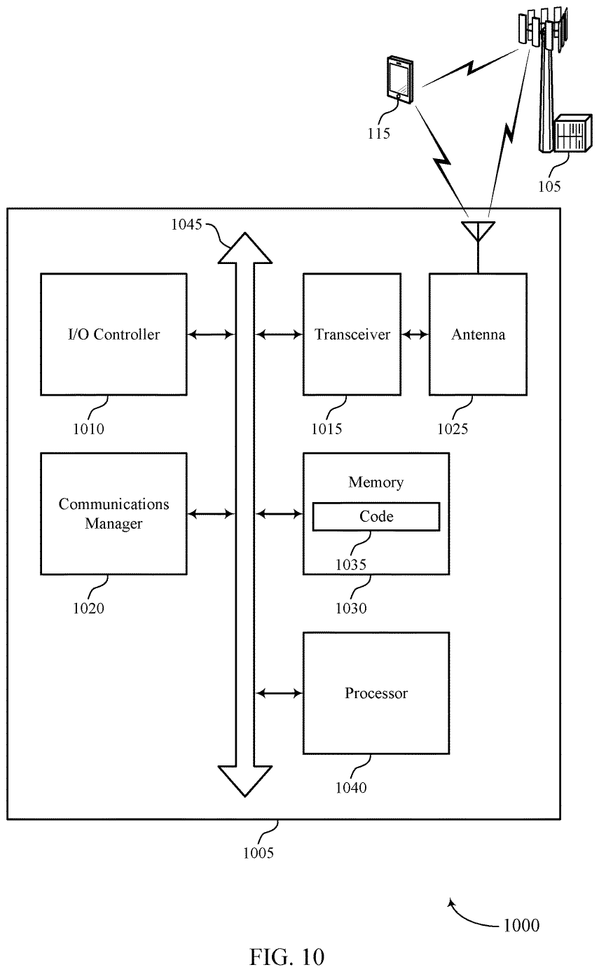

FIG. 10 illustrates a diagram of a system 1000 including a device 1005 that supports inter-UE coordination with COT sharing for sidelink in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting inter-UE coordination with COT sharing for sidelink). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communications at a first UE in accordance with examples as disclosed herein. For example, the communications manager 1020 may be configured as or otherwise support a means for transmitting one or more first sidelink messages initiating a COT, the one or more first sidelink messages including a first set of parameters associated with the COT being shared with at least a second UE, a third UE, or both, where the first set of parameters indicate time and frequency resources within the shared COT. The communications manager 1020 may be configured as or otherwise support a means for receiving, from the second UE, the third UE, or both, one or more second sidelink messages during the shared COT in response to transmitting the one or more first sidelink messages.

Additionally, or alternatively, the communications manager 1020 may support wireless communications at a first UE in accordance with examples as disclosed herein. For example, the communications manager 1020 may be configured as or otherwise support a means for receiving, from a second UE, one or more first sidelink messages initiating a COT, the one or more first sidelink messages including a first set of parameters associated with the COT being shared with at least a second UE, a third UE, or both, where the first set of parameters indicate time and frequency resources within the shared COT. The communications manager 1020 may be configured as or otherwise support a means for transmitting one or more second sidelink messages during the shared COT in response to receiving the one or more first sidelink messages.

By including or configuring the communications manager 1020 in accordance with examples as described herein, the device 1005 may support techniques for inter-UE coordination with COT sharing for sidelink which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of inter-UE coordination with COT sharing for sidelink as described herein, or the processor 1040 and the memory 1030 may be otherwise configured to perform or support such operations.

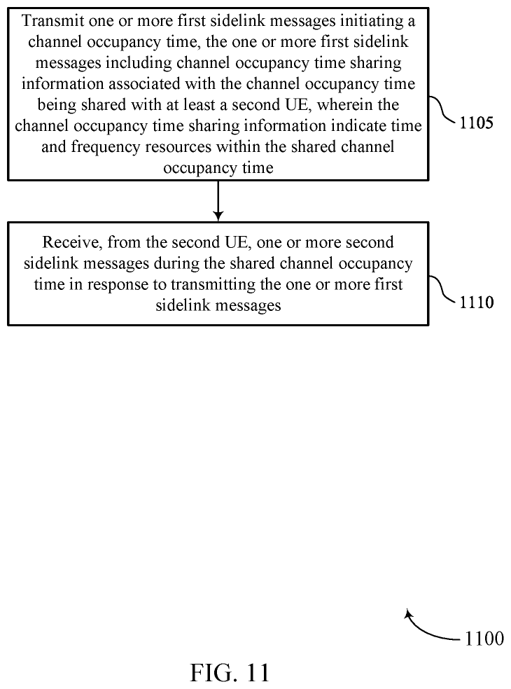

FIG. 11 illustrates a flowchart showing a method 1100 that supports inter-UE coordination with COT sharing for sidelink in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include transmitting one or more first sidelink messages initiating a COT, the one or more first sidelink messages including COT sharing information associated with the COT being shared with at least a second UE, where the COT sharing information indicates time and frequency resources within the shared COT. The operations of 1105 may be performed in accordance with examples as disclosed herein. In some examples, aspects of the operations of 1105 may be performed by a parameter component 925 as described with reference to FIG. 9.

At 1110, the method may include receiving, from the second UE, one or more second sidelink messages during the shared COT in response to transmitting the one or more first sidelink messages. The operations of 1110 may be performed in accordance with examples as disclosed herein. In some examples, aspects of the operations of 1110 may be performed by a COT sharing component 930 as described with reference to FIG. 9.

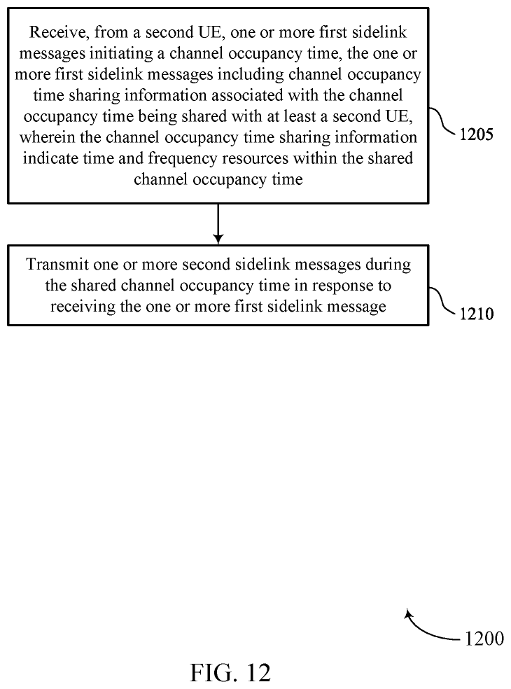

FIG. 12 illustrates a flowchart showing a method 1200 that supports inter-UE coordination with COT sharing for sidelink in accordance with one or more aspects of the present disclosure. The operations of the method 1200 may be implemented by a UE or its components as described herein. For example, the operations of the method 1200 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1205, the method may include receiving, from a second UE, one or more first sidelink messages initiating a COT, the one or more first sidelink messages including COT sharing information associated with the COT being shared with at least a second UE, where the COT sharing information indicates time and frequency resources within the shared COT. The operations of 1205 may be performed in accordance with examples as disclosed herein. In some examples, aspects of the operations of 1205 may be performed by a parameter component 925 as described with reference to FIG. 9.

At 1210, the method may include transmitting one or more second sidelink messages during the shared COT in response to receiving the one or more first sidelink messages. The operations of 1210 may be performed in accordance with examples as disclosed herein. In some examples, aspects of the operations of 1210 may be performed by a COT sharing component 930 as described with reference to FIG. 9.

The following provides an overview of aspects of the present disclosure:

Aspect 1: A method for wireless communications at a first UE, comprising: transmitting one or more first sidelink messages initiating a COT, the one or more first sidelink messages include a first set of parameters associated with the COT being shared with at least a second UE, a third UE, or both, wherein the first set of parameters indicate time and frequency resources within the shared COT; and receiving, from the second UE, the third UE, or both, one or more second sidelink messages during the shared COT in response to transmitting the one or more first sidelink messages.

Aspect 2: The method of aspect 1, wherein the time and frequency resources are allocated to the second UE, the third UE, or both, and wherein receiving the one or more second sidelink messages comprises: receiving the one or more second sidelink messages via at least a subset of the time and frequency resources based at least in part on the time and frequency resources being allocated to the second UE, the third UE, or both.

Aspect 3: The method of any of aspects 1 through 2, wherein the time and frequency resources are restricted from use by the second UE, the third UE, or both, and wherein receiving the one or more second sidelink messages comprises: receiving the one or more second sidelink messages outside of the time and frequency resources based at least in part on the time and frequency resources being restricted from use by the second UE, the third UE, or both.

Aspect 4: The method of any of aspects 1 through 3, wherein transmitting the one or more first sidelink messages initiating the COT comprises: unicasting, broadcasting, or groupcasting, the one or more first sidelink messages.

Aspect 5: The method of aspect 4, wherein unicasting the one or more first sidelink messages initiating the COT comprises: unicasting a third sidelink message of the one or more first sidelink messages to the second UE or the third UE; and unicasting a fourth sidelink message of the one or more first sidelink messages to the second UE or the third UE.

Aspect 6: The method of any of aspects 1 through 5 further comprising: transmitting a third sidelink message sharing the COT, the third sidelink message including a second set of parameters associated with the shared COT, wherein the second set of parameters indicate second time and frequency resources within the shared COT; and receiving one or more fourth sidelink messages during the shared COT based at least in part on the second set of parameters.

Aspect 7: The method of aspect 6, wherein the COT is shared with at least the second UE, the third UE, a fourth UE, or any combination thereof, and the one or more fourth sidelink messages are received from the second UE, the third UE, or the fourth UE, or combination thereof.

Aspect 8: The method of any of aspects 1 through 7, wherein receiving the one or more second sidelink messages comprises: receiving, from the second UE or the third UE, the one or more second sidelink messages based at least in part on a first ID associated with the shared COT matching a second ID associated with the second UE or the third UE, respectively, wherein the first set of parameters comprises the first ID.

Aspect 9: The method of aspect 8, wherein the first ID is a UE ID or a destination ID.

Aspect 10: The method of any of aspects 8 through 9, wherein the one or more first sidelink messages indicate a second set of parameters associated with second time and frequency resources within the COT, the method further comprising: receiving, from the second UE or the third UE, one or more third sidelink messages based at least in part on a third ID associated with the shared COT matching a fourth ID associated with the second UE or the third UE, respectively, wherein the second set of parameters comprises the third ID.

Aspect 11: The method of any of aspects 1 through 10, wherein the first set of parameters comprises one or more offsets, one or more durations, one or more starting points, one or more RB sets, one or more subchannels, one or more interlaces, or any combination thereof, associated with the time and frequency resources.

Aspect 12: The method of any of aspects 1 through 11, wherein the first set of parameters comprises one or more UE IDs, one or more destination IDs, one or more priorities, one or more channel access priority classes, or any combination thereof.

Aspect 13: The method of any of aspects 1 through 12, wherein receiving the one or more second sidelink messages comprises: receiving the one or more second sidelink messages based at least in part on a destination ID associated with the one or more second sidelink messages matching an IDs associated with the first UE.

Aspect 14: A method for wireless communications at a first UE, comprising: receiving, from a second UE, one or more first sidelink messages initiating a COT, the one or more first sidelink messages include a first set of parameters associated with the COT being shared with at least a second UE, a third UE, or both, wherein the first set of parameters indicate time and frequency resources within the shared COT; and transmitting one or more second sidelink messages during the shared COT in response to receiving the one or more first sidelink message.

Aspect 15: The method of aspect 14, wherein the time and frequency resources are allocated to the first UE, the third UE, or both, and wherein transmitting the one or more second sidelink messages comprises: transmitting the one or more second sidelink messages via at least a subset of the time and frequency resources based at least in part on the time and frequency resources being allocated to at least the first UE.

Aspect 16: The method of aspect 15, further comprising: selecting the subset of the time and frequency resources based at least in part on the time and frequency resources being allocated to at least the first UE.

Aspect 17: The method of aspect 16, wherein the subset of the time and frequency resources are selected randomly.

Aspect 18: The method of any of aspects 16 through 17, further comprising: measuring a channel associated with the COT over the time and frequency resources, wherein selecting the subset of the time and frequency resources is based at least in part on the measuring.

Aspect 19: The method of any of aspects 14 through 18, wherein the time and frequency resources are restricted from use by the first UE, the third UE, or both, and wherein transmitting the one or more second sidelink messages comprises: transmitting the one or more second sidelink messages outside of the time and frequency resources based at least in part on the time and frequency resources being restricted from use by at least the first UE.

Aspect 20: The method of any of aspects 14 through 19, further comprising: receiving a third sidelink message sharing the COT, the third sidelink message including a second set of parameters associated with the shared COT, wherein the second set of parameters indicate second time and frequency resources within the shared COT; and transmitting one or more fourth sidelink messages during the shared COT based at least in part on the second set of parameters.

Aspect 21: The method of any of aspects 14 through 20, wherein transmitting the one or more second sidelink messages comprises: transmitting the one or more second sidelink messages based at least in part on a first ID associated with the shared COT matching an second ID associated with the first UE, wherein the first set of parameters comprises the first ID.

Aspect 22: The method of aspect 21, further comprising: validating the first ID associated with the time and frequency resources matches the second ID associated with the first UE.

Aspect 23: The method of any of aspects 21 through 22, wherein the first ID is a UE ID or a destination ID.

Aspect 24: The method of any of aspects 14 through 23, wherein the first set of parameters comprises one or more offsets, one or more durations, one or more starting points, one or more RB sets, one or more subchannels, one or more interlaces, or any combination thereof, associated with the time and frequency resources.

Aspect 25: The method of any of aspects 14 through 24, wherein the first set of parameters comprises one or more UE IDs, one or more destination IDs, one or more priorities, one or more channel access priority classes, or any combination thereof.

Aspect 26: The method of any of aspects 14 through 25, further comprising: transmitting, to a fourth UE, a third sidelink message signaling a second set of parameters enabling the COT to be shared with at least the second UE and the fourth UE, wherein the second set of parameters indicate at least a subset of the time and frequency resources within the shared COT.

Aspect 27: The method of any of aspects 14 through 26, wherein the one or more second sidelink messages comprises an indication of a destination ID matching an ID associated with the second UE.

Aspect 28: An apparatus for wireless communications at a first UE, comprising a processor; memory coupled with the processor; and instructions stored in the memory and executable by the processor to cause the apparatus to perform a method of any of aspects 1 through 13.

Aspect 29: An apparatus for wireless communications at a first UE, comprising at least one means for performing a method of any of aspects 1 through 13.

Aspect 30: A non-transitory computer-readable medium storing code for wireless communications at a first UE, the code comprising instructions executable by a processor to perform a method of any of aspects 1 through 13.

Aspect 31: An apparatus for wireless communications at a first UE, comprising a processor; memory coupled with the processor; and instructions stored in the memory and executable by the processor to cause the apparatus to perform a method of any of aspects 14 through 27.

Aspect 32: An apparatus for wireless communications at a first UE, comprising at least one means for performing a method of any of aspects 14 through 27.

Aspect 33: A non-transitory computer-readable medium storing code for wireless communications at a first UE, the code comprising instructions executable by a processor to perform a method of any of aspects 14 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A first user equipment (UE), comprising:
one or more memories storing processor-executable code; and one or more processors coupled with the one or more memories and operable to execute the code to cause the first UE to:
transmit one or more first sidelink messages initiating a channel occupancy time, the one or more first sidelink messages including channel occupancy time sharing information associated with the channel occupancy time being shared with at least a second UE, wherein the channel occupancy time sharing information indicates time and frequency resources within the shared channel occupancy time; and
receive, from the second UE, one or more second sidelink messages during the shared channel occupancy time in response to transmitting the one or more first sidelink messages.

2. The first UE of claim 1, the one or more processors are operable to execute the code to cause the first UE to:
receive a configuration message indicating one or more parameters associated with sharing the channel occupancy time.

3. The first UE of claim 2, wherein the one or more parameters comprises an indication of enabling or disabling COT sharing, one or more starting points, or both.

4. The first UE of claim 1, wherein the channel occupancy time sharing information comprises one or more durations, one or more resource block sets, or both, associated with the time and frequency resources.

5. The first UE of claim 1, wherein the channel occupancy time sharing information is transmitted via sidelink control information format 2.

6. The first UE of claim 1, wherein the channel occupancy time sharing information comprises one or more UE identifiers, one or more destination identifiers, one or more channel access priority classes, or any combination thereof.

7. The first UE of claim 1, wherein the one or more second sidelink messages are received via groupcast or broadcast, and wherein to receive the one or more second sidelink messages, the one or more processors are operable to execute the code to cause the first UE to:
receive, from the second UE, the one or more second sidelink messages based at least in part on a first destination identifier associated with the one or more first sidelink messages matching a second destination identifier associated with the one or more second sidelink messages.

8. The first UE of claim 1, wherein the one or more second sidelink messages are received via unicast, and wherein to receive the one or more second sidelink messages, the one or more processors are operable to execute the code to cause the first UE to:
receive, from the second UE, the one or more second sidelink messages based at least in part on a first destination identifier and a first source identifier associated with the one or more first sidelink messages matching a second source identifier and a second destination identifier, respectively, associated with the one or more second sidelink messages.

9. The first UE of claim 1, wherein, to receive the one or more second sidelink messages, the one or more processors are operable to execute the code to cause the first UE to:
receive the one or more second sidelink messages within the time and frequency resources based at least in part on the time and frequency resources being allocated for sharing the channel occupancy time.

10. The first UE of claim 1, wherein, to transmit the one or more first sidelink messages initiating the channel occupancy time, the one or more processors are operable to execute the code to cause the first UE to:
unicast, broadcasting, or groupcasting, the one or more first sidelink messages.

11. The first UE of claim 1, wherein the channel occupancy time sharing information comprises one or more offsets, one or more subchannels, one or more interlaces, or any combination thereof, associated with the time and frequency resources.

12. The first UE of claim 1, wherein, to receive the one or more second sidelink messages, the one or more processors are operable to execute the code to cause the first UE to:
receive the one or more second sidelink messages based at least in part on a destination identifier associated with the one or more second sidelink messages matching an identifier associated with the first UE.

13. A first user equipment (UE), comprising:
one or more memories storing processor-executable code; and one or more processors coupled with the one or more memories and operable to execute the code to cause the first UE to:
receive, from a second UE, one or more first sidelink messages initiating a channel occupancy time, the one or more first sidelink messages including channel occupancy time sharing information associated with the channel occupancy time being shared with at least a second UE, wherein the channel occupancy time sharing information indicates time and frequency resources within the shared channel occupancy time; and
transmit one or more second sidelink messages during the shared channel occupancy time in response to receiving the one or more first sidelink messages.

14. The first UE of claim 13, the one or more processors are operable to execute the code to cause the first UE to:
receive a configuration message indicating one or more parameters associated with sharing the channel occupancy time.

15. The first UE of claim 14, wherein the one or more parameters comprises an indication of enabling or disabling COT sharing, one or more starting points, or both.

16. The first UE of claim 13, wherein the channel occupancy time sharing information comprises one or more durations, one or more resource block sets, or both, associated with the time and frequency resources.

17. The first UE of claim 13, wherein the channel occupancy time sharing information is transmitted via sidelink control information format 2.

18. The first UE of claim 13, wherein the channel occupancy time sharing information comprises one or more UE identifiers, one or more destination identifiers, one or more channel access priority classes, or any combination thereof.

19. The first UE of claim 13, wherein the one or more second sidelink messages are groupcast or broadcast, and wherein to transmit the one or more second sidelink messages, the one or more processors are operable to execute the code to cause the first UE to:
transmit the one or more second sidelink messages based at least in part on a first destination identifier associated with the one or more first sidelink messages matching a second destination identifier associated with the one or more second sidelink messages.

20-28. (canceled)

29. A method for wireless communications at a first user equipment (UE), comprising:
transmitting one or more first sidelink messages initiating a channel occupancy time, the one or more first sidelink messages including channel occupancy time sharing information associated with the channel occupancy time being shared with at least a second UE, wherein the channel occupancy time sharing information indicates time and frequency resources within the shared channel occupancy time; and receiving, from the second UE, one or more second sidelink messages during the shared channel occupancy time in response to transmitting the one or more first sidelink messages.

30. (canceled)
